(19) United States
(12) Patent Application Publication
(10) Pub. No.: US 2024/0039426 A1
(43) Pub. Date: Feb. 1, 2024

(54) CONTROL DEVICE, CONTROL SYSTEM, CONTROL METHOD, STORAGE MEDIUM, ELECTRIC VEHICLE, LEARNING DEVICE, AND LEARNED MODEL

(71) Applicant: Mitsubishi Electric Corporation, Tokyo (JP)

(72) Inventor: Noboru MIYAMOTO, Tokyo (JP)

(73) Assignee: Mitsubishi Electric Corporation, Tokyo (JP)

(21) Appl. No.: 18/254,654

(22) PCT Filed: Feb. 17, 2021
(86) PCT No.: PCT/JP2021/005887

§ 371 Date: May 26, 2023

(51) Int. Cl. H02M 7/5387; B60L 50/51; B60L 58/12; B60L 50/60

(52) U.S. Cl. CPC H02M 7/53873; B60L 50/51; B60L 58/12; B60L 50/60; B60L 2210/40

(57) ABSTRACT

A control system of the present disclosure is a control system for controlling an operation of a power converter which performs power conversion between a motor for driving a vehicle and a power supply, and includes a data acquisition unit for acquiring data from equipment inside a vehicle and a control unit for reducing a drive frequency of a switching element included in the power converter when it is determined, on the basis of the data acquired by the data acquisition unit, that it is a state where a driver can allow a noise.

### TECHNICAL FIELD

The present disclosure relates to a control device, a control system, a control method, a program, an electric vehicle, a learning device, and a learned model.

### BACKGROUND ART

As a background-art control device of an electric vehicle, for example, Patent Document 1 discloses a control device which determines a drive number of a power converter and a frequency of a carrier signal to be used for generating a drive signal, on the basis of the total amount of inflow current to a plurality of power converters. This control device predicts a load of a vehicle on the basis of information of a scheduled travel route of the vehicle, and when the predicted load is higher than a current load, the control device increases the determined drive number and reduces the determined frequency. It is disclosed that on the basis of the prediction of a future load, by increasing the drive number of the power converter before the current load increases and reducing a carrier frequency when a high load is predicted, it is possible to suppress heat generation of the power converter. The information of the scheduled travel route is typically gradient information of the scheduled travel route, and it is also disclosed that the drive number may be deter pined on the basis of an accelerator pedal opening, a motor output, or a target output of a motor, instead of the total amount of inflow current.

On the other hand, Patent Document 2 discloses a control device of an electric vehicle which includes a detection unit for detecting occurrence of a load operation which causes charge and discharge of a power storage device so as to raise a temperature of a switching element and a limit setting unit for setting a limiting value in power conversion for suppressing a passing current of the switching element in accordance with the amount of variation in the temperature of the switching element in each load operation. According to Patent Document 2, a temperature rising phase in which the amount of variation in the temperature leading to a heat stress of the switching element is generated is caused by the load operation which causes charge and discharge of a main battery, such as an accelerator operation of a driver, a startup of an engine, a high vehicle deceleration, or the like. According to the control device disclosed in Patent Document 2, in a case where the amount of rise in the temperature increases when the load operation is detected, the passing current of the switching element can be limited by suppressing a battery current or inhibiting the charge and discharge, and as a result of this, the amount of variation in the temperature caused by the heat generation of the switching element can be suppressed.

Further, Patent Document 2 discloses that power loss in the switching element generally increases as the switching frequency increases and as a result of this, a rise of an element temperature becomes severe, and in a case where an element current or a battery current becomes higher than a threshold value when the load operation is detected, an upper limit value of the switching frequency of a converter is reduced to be lower than a default value so as to reduce the switching frequency, and further the element current or the battery current, for example, is acquired as the quantity of state to be used for inferring the amount of rise in the temperature in the load operation and the limiting value in power conversion is set on the basis of the acquired quantity of state.

### PRIOR ART DOCUMENTS

### Patent Document(s)

[Patent Document 1] Japanese Patent Application Laid Open Gazette No. 2020-088870
[Patent Document 2] Japanese Patent Application Laid Open Gazette No. 2012-019587

### SUMMARY

### Problem to be Solved by the Invention

As disclosed in Patent Documents 1 and 2, by reducing a drive frequency of the switching element used in the power converter, it is possible to suppress the heat generation of the switching element. When the drive frequency of the switching element is reduced, however, there arises another problem that a noise occurs since a drive sound enters a human audible range. Such a noise problem is not taken into consideration in Patent Document 1 or 2.

The present disclosure is intended to solve the above-described problem, and it is an object of the present disclosure to suppress heat generation of a switching element and improve drive efficiency thereof while reducing discomfort to a noise generated from a power converter.

### Means to Solve the Problem

The present disclosure is intended for a control system for controlling an operation of a power converter which performs power conversion between a motor for driving a vehicle and a power supply, and the control system includes a data acquisition unit for acquiring data from equipment provided inside a vehicle and a control unit for reducing a drive frequency of a switching element included in the power converter when it is determined, on the basis of the data acquired by the data acquisition unit, that it is a state where a driver can allow a noise.

### Effects of the Invention

According to the present disclosure, since the control system includes the control unit for reducing the drive frequency of the switching element included in the power converter, when it is determined, on the basis of the data acquired by the data acquisition unit, that it is a state where a driver can allow a noise, it is possible to suppress heat generation of the switching element and improve drive efficiency thereof while reducing discomfort to a noise generated from the power converter.

### BRIEF DESCRIPTION OF DRAWINGS

FIG. 1 is a block diagram showing an overall configuration of a control system in accordance with a first preferred embodiment;

FIG. 2 is a view showing a hardware configuration of a control device;

FIG. 3 is a flowchart showing an operation of the control device in accordance with the first preferred embodiment;

FIG. 4 is a block diagram showing an overall configuration of a control system in accordance with a second preferred embodiment;

FIG. 5 is a flowchart showing an operation of the control device in accordance with the second preferred embodiment;

FIG. 6 is a block diagram showing an overall configuration of a control system in accordance with a third preferred embodiment;

FIG. 7 is a flowchart showing an operation of the control device 60 in accordance with the third preferred embodiment;

FIG. 8 is a flowchart showing an operation of the control device in accordance with a variation of the third preferred embodiment;

FIG. 9 is a block diagram showing an overall configuration of a control system in accordance 4 with a fourth preferred embodiment;

FIG. 10 is a flowchart showing an operation of the control device in accordance with the fourth preferred embodiment;

FIG. 11 is a block diagram showing an overall configuration of a control system in accordance with a fifth preferred embodiment;

FIG. 12 is a schematic view showing a configuration of a power converter in accordance with the fifth preferred embodiment;

FIG. 13 is a flowchart showing an operation of the control device in accordance with the fifth preferred embodiment;

FIG. 14 is a flowchart showing an operation of the control device in accordance with a variation of the fifth preferred embodiment;

FIG. 15 is a block diagram showing a configuration of a learning device in accordance with a sixth preferred embodiment;

FIG. 16 is a flowchart relating to a learning process of the learning device in accordance with the sixth preferred embodiment;

FIG. 17 is a block diagram showing a configuration of a control device in accordance with the sixth preferred embodiment;

FIG. 18 is a flowchart relating to an inference process of the control device in accordance with the sixth preferred embodiment; and

FIG. 19 is a schematic view showing a three-layer neural network in accordance with the sixth preferred embodiment.

### DESCRIPTION OF EMBODIMENT(S)

Hereinafter, the preferred embodiments of the present disclosure will be described with reference to attached figures. Further, figures are schematically shown, and the correlation in the size and position of respective images shown in different figures is not always represented accurately but may be changed as appropriate. Furthermore, in the following description, identical constituent elements are represented by the same reference signs and each have the same or similar name and function. Therefore, detailed description thereof will be sometimes omitted.

### The First Preferred Embodiment

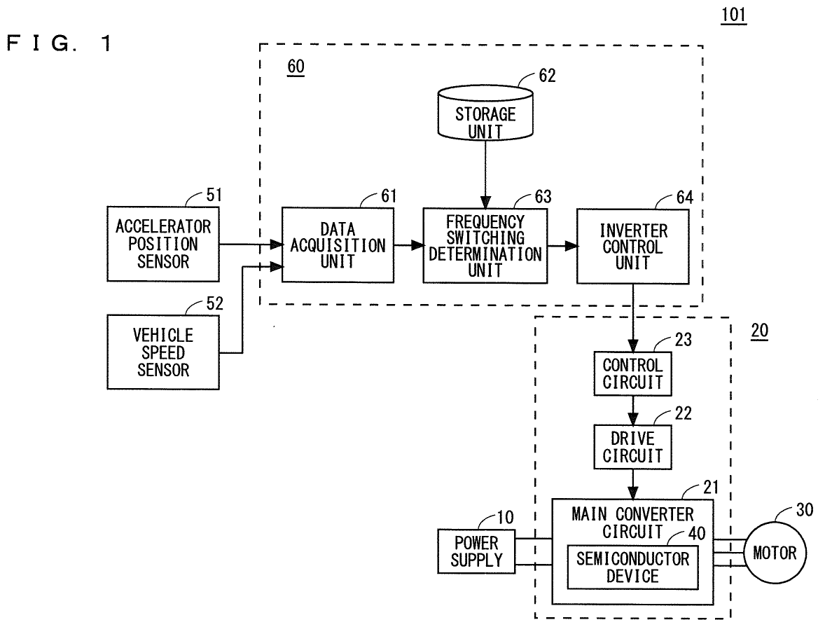

FIG. 1 is a block diagram showing an overall configuration of a control system 101 in accordance with the first preferred embodiment of the present disclosure. Though not shown, the control system 101 is mounted on an electric vehicle using electric drive only or with something, such as a hybrid car, an electric car, or the like, and performs generation or control of a driving force for driving the electric vehicle. As shown in FIG. 1, the control system 101 includes a power supply 10, a power converter 20, a motor 30, a semiconductor device 40, an accelerator position sensor 51, a vehicle speed sensor 52, and a control device 60.

The power supply 10 is a DC power supply and supplies direct current (DC) power to the power converter 20. The power supply 10 can be formed of various elements, and for example, can be formed of a DC system, a solar battery, or a storage battery, or may be formed of a rectifier circuit connected to an AC system, or an AC/DC converter. Further, the power supply 10 may be formed of a DC/DC converter which converts direct current power outputted from the DC system into predetermined electric power.

The power converter 20 is a three-phase inverter which is connected between the power supply 10 and the motor 30, and converts the DC power suppled from the power supply 10 into alternating current (AC) power and supplies the AC power to the motor 30. As shown in FIG. 1, the power converter 20 includes a main converter circuit 21, a drive circuit 22, and a control circuit 23. The main converter circuit 21 converts the DC power inputted from the power supply 10 into the AC power and outputs the AC power to the motor 30. The drive circuit 22 outputs a drive signal used for driving each switching element provided inside the semiconductor device 40 which is a constituent of the main converter circuit 21. The control circuit 23 outputs a control signal used for controlling the drive circuit 22, to the drive circuit 22.

The motor 30 is a three-phase AC motor driven by the AC power supplied from the power converter 20. By driving of the motor 30, generated is the driving force to be used for driving the electric vehicle on which the motor 30 is mounted.

Details of the power converter 20 will be described. The semiconductor device 40 which is a constituent of the main converter circuit 21 includes a switching element and a reflux diode (not shown), and when the switching element performs switching, the semiconductor device 40 converts the DC power supplied from the power supply 10 into the AC power and supplies the AC power to the motor 30. A specific circuit configuration of the main converter circuit 21 may be any one of various configurations, and the main converter circuit 21 in accordance with the present preferred embodiment is a two-level three-phase full-bridge circuit which can be constituted of six switching elements and six reflux diodes which are connected in inverse parallel to the six switching elements, respectively. The six switching elements form (three) upper and lower arms in each of which two switching elements are connected in series to each other, and the upper and lower arms form three phases (U-phase, V-phase, and W-phase) of the full-bridge circuit, respectively. Then, respective output terminals of the upper and lower arms, i.e., three output terminals of the main converter circuit 21 are connected to the motor 30.

Herein, the switching element is a power semiconductor element such as an IGBT (Insulated Gate Bipolar Transistor), a MOSFET (Metal Oxide Semiconductor Field Effect Transistor: insulated gate field effect transistor), or the like, and the reflux diode is a semiconductor element on which an FWD (Free Wheel Diode) such as a PIN (Positive Intrinsic Negative) diode, an SBD (Schottky Barrier Diode), or the like is formed, but these are not limited to the above exemplary elements only if these have the same functions.

Further, though silicon is typically used as a semiconductor material forming the switching element or the reflux diode, the semiconductor material is not particularly limited. For example, a so-called wide bandgap semiconductor which has wider bandgap than silicon may be used. As the wide bandgap semiconductor, for example, used is silicon carbide, gallium nitride, aluminum nitride, aluminum gallium nitride, gallium oxide, diamond, or the like.

Further, the main converter circuit 21 may have a configuration where six semiconductor devices 40 are provided, each having a pair of switching element and reflux diode, where three semiconductor devices 40 are provided, each having two pairs of switching element and reflux diode which form the upper and lower arms, or where one semiconductor device 40 is provided, having six switching elements and six reflux diodes, and the configuration thereof does not matter.

The drive circuit 22 generates the drive signal used for driving the switching element of the semiconductor device 40 and supplies the drive signal to a control electrode of the switching element of the semiconductor device 40. Specifically, in accordance with the control signal from the control circuit 23 described later, the drive circuit 22 outputs a drive signal for bringing the switching element into an On state and another drive signal for bringing the switching element into an OFF state to the control electrode of each switching element. In a case of keeping the switching element in the ON state, the drive signal is a voltage signal (ON signal) having a threshold voltage of the switching element or higher, and in a case of keeping the switching element in the OFF state, the drive signal is a voltage signal (OFF signal) having the threshold voltage of the switching element or lower.

The control circuit 23 controls the switching element of the semiconductor device 40 so that desired electric power should be supplied to the motor 30. Specifically, the control circuit 23 calculates a time (ON time) when each switching element of the semiconductor device 40 comes into the ON state, on the basis of the electric power to be supplied to the motor 30. For example, the main converter circuit 21 can be controlled by the PWM (Pulse Wide Modulation) control to modulate the ON time of the switching element in accordance with the voltage to be outputted. Then, at each point in time, the control circuit 23 outputs a control command (control signal) to the drive circuit 22 so as to output the ON signal to the switching element to be brought into the ON state and output the OFF signal to the switching element to be brought into the OFF state. In accordance with this control signal, the drive circuit 22 outputs the ON signal or the OFF signal as the drive signal to the control electrode of each switching element.

Further, in the first preferred embodiment, the power converter 20 is a two-level three-phase inverter, but the power converter 20 of the present disclosure is not limited to this type. Only if the power converter 20 performs power conversion between the motor and the power supply 10 by driving of the switching element, the power converter 20 may be a three-level or multilevel three-phase inverter or may be a single-phase inverter when power is supplied to a single-phase load. Furthermore, in a case of supplying power to a direct current (DC) load or the like, a DC/DC converter or an AC/DC converter can be adopted as the power converter 20.

The accelerator position sensor 51 is provided inside the electric vehicle and detects an accelerator opening A of the electric vehicle. As well known, an acceleration command and a deceleration/stop command of the electric vehicle given by a driver is inputted by operations of an accelerator pedal and a brake pedal. The accelerator position sensor 51 is generally attached to the accelerator pedal of a vehicle, and detects a position of the accelerator pedal that the driver depresses and measures the amount of accelerator pedal depression. The accelerator position sensor 51 outputs an output signal indicating a voltage in accordance with the amount of accelerator pedal depression by the driver to the control device 60.

The vehicle speed sensor 52 is provided inside the electric vehicle and detects a vehicle speed of the electric vehicle. The vehicle speed sensor 52 is generally a rotation number sensor provided on an axle coupled to a tire and converts the number of rotations detected by the rotation number sensor into a vehicle speed to be used. Like the accelerator position sensor 51, the vehicle speed sensor 52 is also electrically connected to the control device 60. The vehicle speed sensor 52 outputs an output signal indicating the detected vehicle speed.

Further, since the respective constitutions and operations of the accelerator position sensor 51 and the vehicle speed sensor 52 are publicly known, more detailed description thereof will be omitted.

The control device 60 is an electronic control Unit (ECU) for controlling an operation of the power converter 20. In the first preferred embodiment, the control device 60 determines whether or not it is a state where the driver can allow a noise, on the basis of a predicted temperature of the switching element included in the semiconductor device 40 and the vehicle speed of the electric vehicle. The control device 60 has a data acquisition unit 61, a storage unit 62, a frequency switching determination unit 63, and an inverter control unit 64.

The data acquisition unit 61 acquires data from equipment provided inside the electric vehicle. In the first preferred embodiment, the data acquisition unit 61 acquires data of the accelerator opening A of the electric vehicle and data of the vehicle speed of the electric vehicle from the accelerator position sensor 51 and the vehicle speed sensor 52, respectively.

The storage unit 62 stores therein the data to be used for determination of the frequency switching determination unit 63. In more detail, the storage unit 62 stores therein a prediction model used for predicting a future load of the motor 30 or the power converter 20 on the basis of data acquired from the equipment provided inside the electric vehicle and a relational expression used for obtaining a temperature of the switching element on the basis of the load of the motor 30 or the power converter 20 and characteristics of the switching element. In the first preferred embodiment, the storage unit 62 stores therein the prediction model used for predicting the future load of the motor 30 or the power converter 20 on the basis of the data of the accelerator opening A of the electric vehicle. Herein, a correlation between the data of the accelerator opening A of the electric vehicle and the future load of the motor 30 or the power converter 20 may be set in advance experimentally, empirically, or on the basis of a simulation or the like.

Further, the storage unit 62 stores therein data obtained by associating a predetermined traveling pattern of the electric vehicle with a result obtained by determining in advance whether or not the driver can allow a sound generated from the power converter 20 in the traveling pattern, for each traveling pattern. In the first preferred embodiment, the storage unit 62 stores therein data obtained by associating the data of the vehicle speed of the electric vehicle with a result obtained by determining in advance whether or not the driver can allow a sound generated from the power converter 20 at the vehicle speed, for each vehicle speed.

Herein, the data obtained by associating the traveling pattern with the result obtained by determining whether or not the driver can allow a sound generated at that time may be generated, for example, by modeling a relation between the traveling pattern and a sound measured in a cabin of the electric vehicle at a test run in a development and making a questionnaire or the like to collect opinions of a plurality of persons towards the sound generated in an actual run, to thereby set a tolerance.

Further, what level of sound is allowed by the driver in each traveling pattern may be determined by a result of running test, a sense of a test driver in running, a tendency of a relationship between an acceleration request of a vehicle and tuning of a noise in each vehicle manufacturer, or the like. For example, a vehicle prioritizing quietness may make a setting so that the drive frequency is not changed unless a change in the accelerator opening A becomes considerably high, or a vehicle whose noise during acceleration is rather a fascination, such as a sports car or the like, may make a setting to change the drive frequency at an early stage. Thus, a state where a driver can allow a noise, in other words, a traveling pattern of prioritizing the acceleration over the quietness can be determined in advance.

The frequency switching determination unit 63 determines whether or not it is a state where the driver can allow a noise, on the basis of the data acquired by the data acquisition unit 61. In the first preferred embodiment, the frequency switching determination unit 63 determines whether or not it is a state where the driver can allow a noise, on the basis of the data of the accelerator opening A of the electric vehicle and the data of the vehicle speed of the electric vehicle.

In more detail, the frequency switching determination unit 63 predicts the future temperature of the switching element on the basis of the data of the accelerator opening A acquired by the data acquisition unit 61 and the prediction model and the relational expression stored in the storage unit 62. Then, when the predicted temperature of the switching element exceeds a predetermined value, the frequency switching determination unit 63 determines whether or not a current traveling state of the electric vehicle coincides with the predetermined traveling pattern stored in the storage unit 62, on the basis of the data of the vehicle speed acquired by the data acquisition unit 61, and determines whether or not it is a state where the driver can allow a noise, on the basis of the determination result.

Further, in the first preferred embodiment, there may be configuration to make it possible to determine whether or not the predicted temperature of the switching element exceeds the predetermined value by calculating the amount of variation dA/dt in the accelerator opening from the data of the accelerator opening A of the electric vehicle, which are acquired by the data acquisition unit 61, and determining whether or not the amount of variation dA/dt in the accelerator opening exceeds a predetermined threshold value. When the amount of variation dA/dt in the accelerator opening exceeds the predetermined threshold value, it can be determined that the driver requests rapid acceleration and a high load will be applied to the switching element, to thereby raise the temperature thereof in the future. In this case, there may be a configuration where the storage unit 62 stores therein the threshold value to be used for determining the amount of variation dA/dt in the accelerator opening and the frequency switching determination unit 63 determines whether or not the amount of variation dA/dt in the accelerator opening exceeds the threshold value stored in the storage unit 62.

Furthermore, in the first preferred embodiment, there may be a configuration where the frequency switching determination unit 63 can determine whether or not it is a state where the driver can allow a noise by determining whether or not the vehicle speed of the electric vehicle acquired by the data acquisition unit 61 exceeds a predetermined threshold value. When the vehicle speed of the electric vehicle exceeds the predetermined threshold value, it can be determined that the state changes to a highspeed traveling state where the driver can allow a noise or that the driver can allow a noise if the noise increases since it is a high-speed traveling state of the electric vehicle. In this case, there may be a configuration where the storage unit 62 stores therein the threshold value to be used for determining the vehicle speed and the frequency switching determination unit 63 determines whether or not the vehicle speed of the electric vehicle exceeds the threshold value stored in the storage unit 62.

The inverter control unit 64 outputs a target output of the motor 30 and a command on an energizing current and the drive frequency of the switching element to the control circuit 23, to thereby control the operation of the power converter 20. Further, when the frequency switching determination unit 63 determines that it is a state where the driver can allow a noise, the inverter control unit 64 outputs a command to reduce the drive frequency of the switching element included in the power converter 20, to the control circuit 23. In other words, when the amount of variation dA/dt in the accelerator opening of the electric vehicle exceeds the predetermined value and the vehicle speed of the electric vehicle exceeds the predetermined value, the inverter control unit 64 reduces the drive frequency of the switching element.

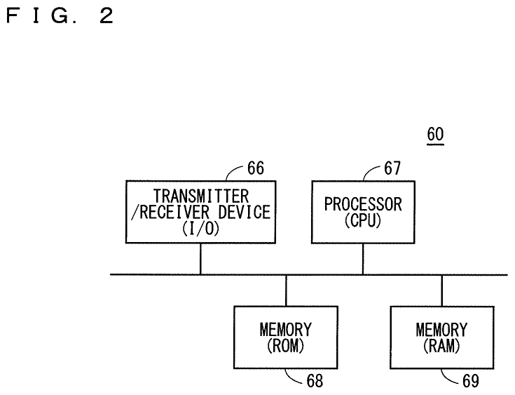

FIG. 2 is a view showing a hardware configuration of the control device 60 in accordance with the first preferred embodiment. The control device 60 includes a transmitter/receiver device 66, a processor (CPU: Central Processing Unit) 67, a memory (ROM: Read Only Memory) 68, and a memory (RAM: Random Access Memory) 69. The control device 60 outputs a command to control the operation of the power converter 20 by causing the processor 67 to execute a predetermined program stored in the memory 68 in advance. The transmitter/receiver device 66 transmits and receives a signal between any one of various equipment connected to the control device 60 and the power converter 20.

In the control device 60, the processor 67 executes the predetermined program stored in the memory 68, to thereby implement various function modules. A control module includes the data acquisition unit 61, the frequency switching determination unit 63, and the inverter control unit 64. Further, the above-described storage unit 62 corresponds to the memories 68 and 69.

Furthermore, each function module of the control device 60 may be implemented by causing the processor 67 to perform a software processing in accordance with the program set in advance, as described above, or as to at least some of the function modules, hardware such as an electronic circuit or the like which has a function corresponding to each function module may perform a predetermined numerical and logical operation processing.

Further, though the present preferred embodiment has the configuration where the single control device 60 controls the operation of the power converter 20 and switches the drive frequency of the switching element, a plurality of control devices (ECU) may perform a cooperative operation, to thereby achieve the same control configuration.

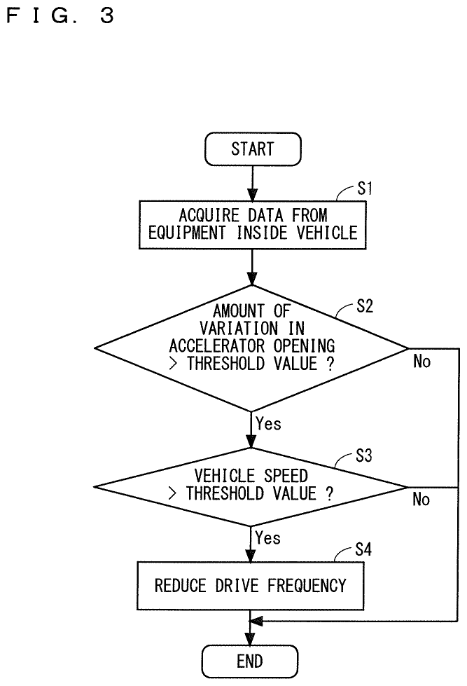

FIG. 3 is a flowchart showing an operation of the control device 60 in accordance with the first preferred embodiment. In a state where the electric vehicle on which the control system 101 is mounted is traveling, the control device 60 performs the process of the flow shown in FIG. 3 as appropriate, always or at a predetermined timing.

In Step S1, the data acquisition unit 61 acquires the output signal indicating the voltage in accordance with the amount of accelerator pedal depression by the driver, as the data of the accelerator opening A of the electric vehicle, from the accelerator position sensor 51. Further, the data acquisition unit 61 acquires the output signal indicating the vehicle speed of the electric vehicle, as the data of the vehicle speed of the electric vehicle, from the vehicle speed sensor 52.

Next, in Step S2, the frequency switching determination unit 63 predicts the future temperature of the switching element and determines whether or not the predicted temperature exceeds a predetermined value, on the basis of the data of the accelerator opening A of the electric vehicle which are acquired by the data acquisition unit 61, the prediction model used for predicting the future load of the motor 30 or the power converter 20 which is stored in the storage unit 62, and the relational expression used for obtaining the temperature of the switching element on the basis of the load of the motor 30 or the power converter 20 and characteristics of the switching element which are stored in the storage unit 62.

Further, the frequency switching determination unit 63 may determines whether or not the predicted temperature of the switching element exceeds the predetermined value by calculating the amount of variation dA/dt in the accelerator opening from the data of the accelerator opening A and determining whether or not the amount of variation dA/dt in the accelerator opening exceeds the predetermined threshold value.

In Step S2, when the amount of variation dA/dt in the accelerator opening of the electric vehicle does not exceed the predetermined threshold value, in other words, when it is determined that the predicted temperature of the switching element does not exceed the predetermined value (“No” in Step S2), the control device 60 ends the process shown in the flow of FIG. 3.

On the other hand, in Step S2, when the amount of variation dA/dt in the accelerator opening of the electric vehicle exceeds the predetermined threshold value, in other words, when it is determined that the predicted temperature of the switching element exceeds the predetermined value (“Yes” in Step S2), the process goes to a determination process of Step S3.

In Step S3, the frequency switching determination unit 63 determines whether or not the current traveling state of the electric vehicle coincides with the predetermined traveling pattern stored in the storage unit 62, on the basis of the data of the vehicle speed of the electric vehicle acquired by the data acquisition unit 61. When the current traveling state of the electric vehicle coincides with the predetermined traveling pattern, the frequency switching determination unit 63 determines whether or not it is a state where the driver can allow a noise, on the basis of a determination result on whether or not the driver can allow a generated sound, which is associated with the predetermined traveling pattern stored in the storage unit 62.

Further, the frequency switching determination unit 63 may determine whether or not it is a state where the driver can allow a noise by determining whether or not the vehicle speed of the electric vehicle exceeds the predetermined threshold value.

In Step S3, when the vehicle speed of the electric vehicle does not exceed the predetermined threshold value, in other words, when it is determined that it is not a state where the driver can allow a noise (“No” in Step S3), the control device 60 ends the process shown in the flow of FIG. 3.

On the other hand, in Step S3, when the vehicle speed of the electric vehicle exceeds the predetermined threshold value, in other words, when it is determined that it is a state where the driver can allow a noise (“Yes” in Step S3), the process goes to a process of Step S4.

In Step S4, the inverter control unit 64 outputs a command to reduce the drive frequency of the switching element included in the power converter 20 to the control circuit 23, on the basis of the determination result of the frequency switching determination unit 63. On the basis of this command, the control circuit 23 outputs a control signal to the drive circuit 22 and the drive circuit 22 outputs a drive signal obtained by reducing the drive frequency to the switching element, to thereby actually reduce the drive frequency of the switching element. Then, the process shown in the flow of FIG. 3 is ended.

Next, drive control of the switching element in the background-art power converter will be described. As disclosed, for example, in Patent Documents 1 and 2, generally, since power loss in the switching element increases as the drive frequency of the switching element becomes higher, it is possible to suppress heat generation of the switching element by reducing the drive frequency of the switching element. Since switching loss generated in the switching element can be obtained by multiplying a loss generated by one switching by the number of repetitions, this is caused by the phenomenon that the number of repetitions increases as the drive frequency becomes higher and conversely the number of repetitions decreases and the switching loss is reduced as the drive frequency becomes lower.

Herein, though the human audible range is generally from 20 Hz to 20 kHz, it is said that a person can hear a sound in a range from 2 kHz to 5 kHz, for example, in the field of inverter control and cannot hear or do not mind any sound in the range over about 8 kHz. For this reason, when the drive frequency of the switching element is reduced, the drive frequency enters the above-described human audible range and the drive sound of the power converter is thereby recognized as a noise.

In order to solve the above-described problem, there is a possible method in which the timing to switch the drive frequency is set to near the limit that the switching element is tolerable. Further, the heatproof temperature of a silicon semiconductor is generally 150° C. and that of silicon carbide is about 200° C., and usually a guaranteed operating temperature is specified for a used semiconductor. For this reason, there is a possible control case where the drive frequency is switched immediately before the temperature reaches the heatproof temperature or the guaranteed operating temperature thereof or where a switching process is performed at about 100° C. in consideration of a sensor error and a delay in processing time on the system side. In this case, however, there is a possibility that a thermal load accompanying a temperature rise of the switching element accumulates in the switching element and the switching element is thereby deteriorated, to make the element life shorter.

On the other hand, when the timing to switch the drive frequency is advanced, as the countermeasure against a noise, for example, it becomes necessary to add components, such as attaching a sound absorbing material on a wall (bulkhead) portion separating an engine compartment under a bonnet on which the power converter is mounted in the electric vehicle from the inside of the cabin or under the bonnet, or the like.

Further, in a case where the power converter is an inverter, when the drive frequency of the switching element is switched during the operation of the inverter, there arises a problem that the drive pulse width of the switching element increases at the moment when the drive frequency is switched and a short circuit or the like occurs. As the countermeasure against this, it is necessary to use a method of switching the drive frequency stepwise, or the like, but when the temperature of the switching element sharply rises, there is a possibility that there occurs a delay in switching of the drive frequency and the temperature of the switching element becomes high.

In contrast to this, the control system 101 of the first preferred embodiment includes the control device 60 having the data acquisition unit 61 for acquiring the data from the equipment inside the electric vehicle and the inverter control unit 64 for reducing the drive frequency of the switching element included in the power converter 20 when it is determined, on the basis of the data acquired by the data acquisition unit 61, that it is a state where the driver can allow a noise.

Since the control system 101 of the first preferred embodiment reduces the drive frequency of the switching element in the state where the driver can allow a noise, it is possible to reduce the loss of the switching element and suppress the heat generation without causing the driver to feel a sound generated from the power converter 20 as a noise. Therefore, it is possible to suppress the heat generation of the switching element and improve the drive efficiency thereof while reducing the discomfort to the noise generated from the power converter.

Further, according to the control system 101 of the first preferred embodiment, on the basis of the data of the already-existing sensor such as the accelerator position sensor 51, the vehicle speed sensor 52, or the like, an operation to raise the temperature of the switching element of the power converter 20 is predicted, and switching control to reduce the drive frequency is performed so that the temperature of the switching element should become lower before the temperature of the switching element actually becomes higher in a state where the drivability of the driver is not damaged. It is thereby prevent a delay in switching of the drive frequency from occurring as conventionally.

Furthermore, though the heatproof temperature or the guaranteed operating temperature of the semiconductor is generally specified, since the drive frequency is changed so as to preventive-safely reduce the load in a stage where the temperature of the switching element is still low, it is possible to reliably avoid a high temperature operation of the switching element and ensure a safe operation within the specified temperature.

Further, in a case where the switching element is a MOSFET formed of silicon carbide (SiC) or the like, since the MOSFET generally has resistance characteristics, loss increases as the temperature rises. In contrast to this, according to the first preferred embodiment, an effect of reducing the loss can be also produced by suppressing the temperature of the switching element.

Furthermore, when it is determined that it is a state where the driver can allow a noise, regardless of the temperature of the switching element and the load state, the drive frequency may be actively reduced for the purpose of reducing the above-described switching loss or the loss accompanying the temperature rise specific to the MOSFET.

Further, as described above, the reduction in the drive frequency causes a rise in inverter sound, but since the switching operation is performed in the state where the driver can allow a noise, it is possible to prevent driver's fatigue due to the noise or damage in the drivability, and also possible to reduce the amount of sound absorbing materials or the like mounted to prevent the inverter sound from being heard by the driver.

In other words, according to the control system 101 of the first preferred embodiment, it is possible to achieve compatibility between the drivability of the driver and the safety of the device and also possible to ensure cost reduction of the vehicle since unnecessary sound absorbing materials or the like can be omitted.

Further, though the control system 101 of the first preferred embodiment has the configuration where the main converter circuit 21 is formed of the semiconductor device 40 having one or the plurality of pairs of switching element and the reflux diode and the drive signal from the drive circuit 22 is supplied to the switching element of the semiconductor device 40, this is only one exemplary configuration. For example, the semiconductor device 40 may be formed as a so-called IPM (Intelligent Power Module) which is a single package including therein the drive circuit 22, any other protection circuit, or the like, additionally to one or the plurality of pair of switching element and reflux diode.

Furthermore, though the control system 101 of the first preferred embodiment has the configuration where the inverter control unit 64 outputs the command relating to the drive frequency of the switching element or the like to the control circuit 23, the control circuit 23 outputs the control signal to the drive circuit 22, and the drive circuit 22 outputs the drive signal to the switching element, this is only one exemplary configuration. The control system 101 may have a configuration, for example, where the inverter control unit 64 outputs the drive signal to each of the switching elements constituting the main converter circuit 21, instead of the drive circuit 22, so as to drive these elements. In this case, in Step S4 of FIG. 3, the inverter control unit 64 directly outputs the drive signal obtained by actually reducing the drive frequency to the switching element, instead of outputting the command to reduce the drive frequency of the switching element to the control circuit 23. In the case of having such a configuration, there arises an advantage that the drive circuit 22 and the control circuit 23 become unnecessary. Further, in this case, the drive signal obtained by actually reducing the drive frequency corresponds to the command to reduce the drive frequency of the switching element.

Moreover, though the control system 101 of the first preferred embodiment has the configuration where the data acquisition unit 61 acquires the data directly from the accelerator position sensor 51 and the vehicle speed sensor 52, this is only one exemplary configuration. There may be a configuration, for example, where the control system 101 further includes a not-shown host controller (upper controller) and the host controller acquires the data from the equipment provided inside the electric vehicle, such as the accelerator position sensor 51, the vehicle speed sensor 52, or the like, and outputs the acquired data to the data acquisition unit 61.

Further, these variations can be applied to the following preferred embodiments in the same way.

### The Second Preferred Embodiment

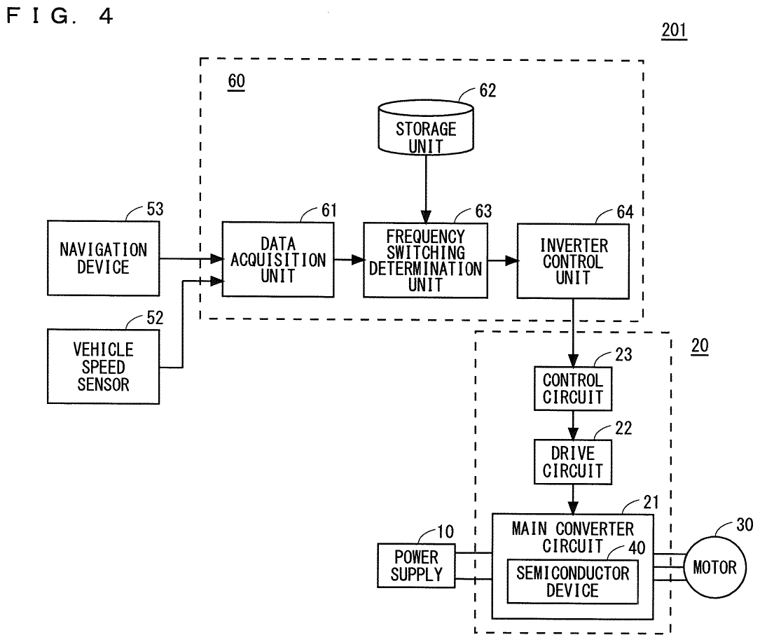

FIG. 4 is a block diagram showing an overall configuration of a control system 201 in accordance with the second preferred embodiment. The control system 201 of the second preferred embodiment is different from the control system 101 of the first preferred embodiment in that data acquired from a navigation device 53 are used, instead of the data acquired from the accelerator position sensor 51. Further, since the control system 201 of the second preferred embodiment is almost common to the control system 101 of the first preferred embodiment, description will be made below, centering on the difference with the control system 101, and description on the constituent elements, the operation, or the like common to those of the control system 101 will be omitted as appropriate.

As shown in FIG. 4, the control system 201 of the second preferred embodiment includes the power supply 10, the power converter 20, the motor 30, the semiconductor device 40, the vehicle speed sensor 52, the navigation device 53, and the control device 60.

The navigation device 53 is provided inside the electric vehicle and includes a location search system such as a GPS (Global Positioning System) or the like and map data. The navigation device 53 has a configuration to specify a current position of the self-vehicle on the map on the basis of position information acquired via the GPS and to output the current position superposed on map information on a not-shown display device. The navigation device 53 stores therein road information of a gradient of a road, a speed limit, or the like. The navigation device 53 has a configuration to acquire information on the latitude, longitude, and altitude of the current position of the electric vehicle by using the GPS, to generate, for example, gradient information, road information, various information, or the like on the road on which the electric vehicle travels, and to output the generated information on the not-shown display device. The gradient information refers to information about the absolute gradient of the road surface on which the electric vehicle is traveling.

Further, the navigation device 53 can search for a route from the current position to a destination set by a user and display information of a scheduled travel route which is the retrieved route on the display device, to thereby present the information to the user (driver). Further, the scheduled travel route refers to a route part immediately in front of the electric vehicle among the route to the destination in the case where the destination is set, and refers to a road in front of the electric vehicle in the case where the destination is not set.

Furthermore, the navigation device 53 may have a configuration where only the display device and a human-machine interface (HMI) are mounted inside the vehicle and a device body including a storage medium storing therein the data and a program is formed of a device (server) outside the vehicle, which is connected wirelessly to the vehicle. Further, the navigation device 53 may be a device for specifying the current position or the scheduled travel route of the electric vehicle in conjunction with a mobile terminal, a smart watch, or the like that the driver has. In this case, there may be a configuration where the electric vehicle includes an interface device for performing communication with the mobile terminal or the smart watch and data on the scheduled travel route are inputted to the data acquisition unit 61 through the interface device.

The navigation device 53 is electrically connected to the control device 60 and outputs the data on the scheduled travel route of the electric vehicle to the control device 60.

Further, since the constitution and operation of the navigation device 53 are publicly known, more detailed description thereof will be omitted.

In the second preferred embodiment, the data acquisition unit 61 of the control device 60 acquires the data on the scheduled travel route of the electric vehicle from the navigation device 53. The data on the scheduled travel route include information relating to a gradient of a road surface on which the electric vehicle travels. Herein, the road surface on which the electric vehicle travels includes at least a road surface on which the electric vehicle is traveling at this point in time and further is a concept also comprehending a road surface on which the electric vehicle can travel near-futuristically. Further, like in the first preferred embodiment, the data acquisition unit 61 acquires the data of the vehicle speed of the electric vehicle from the vehicle speed sensor 52 provided inside the electric vehicle.

In the second preferred embodiment, the storage unit 62 stores therein the prediction model used for predicting the future load of the motor 30 or the power converter 20 on the basis of the data on the scheduled travel route of the electric vehicle. Herein, a correlation between the data on the scheduled travel route of the electric vehicle and the future load of the motor 30 or the power converter 20 may be set in advance experimentally, empirically, or on the basis of a simulation or the like.

Further, like in the first preferred embodiment, the storage unit 62 stores therein data obtained by associating the data of the vehicle speed of the electric vehicle with a result obtained by determining in advance whether or not the driver can allow a sound generated from the power converter 20 at the vehicle speed, for each vehicle speed. Herein, the data obtained by associating the traveling pattern with the result obtained by determining whether or not the driver can allow a sound generated at that time can be generated in the same way as in the first preferred embodiment.

In the second preferred embodiment, the frequency switching determination unit 63 predicts that the load of the electric vehicle will increase in the future, on the basis of the data on the scheduled travel route which are acquired by the data acquisition unit 61, the prediction model and the relational expression stored in the storage unit 62, and predicts the temperature of the switching element at that time.

Further, in the second preferred embodiment, the frequency switching determination unit 63 predicts whether or not the load of the electric vehicle will increases in the future, on the basis of the information on the gradient of the road surface on which the electric vehicle travels, which are included in the data on the scheduled travel route. Specifically, the frequency switching determination unit 63 may have a configuration to analyze the information on the gradient of the road surface on which the electric vehicle travels and to determine whether or not it is predicted that the electric vehicle will enter a climbing road in the future, in other words, whether or not it is presumed that the electric vehicle will be traveling on a climbing road near-futuristically, to thereby determine whether or not the predicted temperature of the switching element exceeds a predetermined value. When it is predicted that the electric vehicle will enter a high gradient climbing road, since the load of the electric vehicle is predicted to increase in the future, it can be determined that a high load is applied to the switching element and the temperature thereof rises in the future. In this case, there may be a configuration where the storage unit 62 stores therein a threshold value to be used for determining the gradient of the road surface and the frequency switching determination unit 63 determines whether or not the gradient of the road surface on which the electric vehicle travels exceeds the threshold value stored in the storage unit 62.

Alternatively, the frequency switching determination unit 63 may determine that a predicted load is higher than a current load when the gradient of a front road surface (scheduled travel route) is higher than that of a road surface immediately below the electric vehicle and may determine that the predicted load is lower than the current load when the gradient of the front road surface is lower than that of the road surface immediately below the electric vehicle.

Then, when the predicted temperature of the switching element exceeds the predetermined value, the frequency switching determination unit 63 determines whether or not it is a state where the driver can allow a noise, on the basis of the data of the vehicle speed of the electric vehicle, like in the first preferred embodiment. When the vehicle speed of the electric vehicle exceeds a predetermined value, since it can be determined that the driver selects to acceleratingly climb the road, it can be determined that it is a state where the driver can allow a noise.

Like in the first preferred embodiment, when the frequency switching determination unit 63 determines that it is a state where the driver can allow a noise, the inverter control unit 64 outputs the command to reduce the drive frequency of the switching element included in the power converter 20 to the control circuit 23. In other words, when it is predicted that the load of the electric vehicle will increase from the data on the scheduled travel route of the electric vehicle and the vehicle speed of the electric vehicle exceeds the predetermined value, the inverter control unit 64 reduces the drive frequency of the switching element.

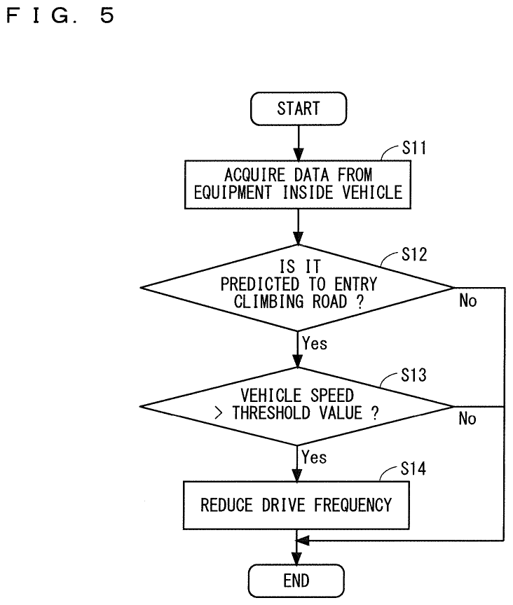

FIG. 5 is a flowchart showing an operation of the control device 60 in accordance with the second preferred embodiment. In Step S11, the data acquisition unit 61 acquires the data on the scheduled travel route of the electric vehicle from the navigation device 53 and acquires the data of the vehicle speed of the electric vehicle from the vehicle speed sensor 52.

In Step S12, the frequency switching determination unit 63 predicts the future temperature of the switching element and determines whether or not the predicted temperature exceeds the predetermined value, on the basis of the data on the scheduled travel route, the prediction model used for predicting the future load of the motor 30 or the power converter 20 which is stored in the storage unit 62, and the relational expression used for obtaining the temperature of the switching element on the basis of the load of the motor 30 or the power converter 20 and characteristics of the switching element which are stored in the storage unit 62.

Further, the frequency switching determination unit 63 may determine whether or not the predicted temperature of the switching element exceeds the predetermined value by analyzing the information on the gradient of the road surface on which the electric vehicle travels, from the data on the scheduled travel route, and determining whether or not the gradient of the road surface on which the electric vehicle travels exceeds the predetermined threshold value.

In Step S12, when the gradient of the road surface on which the electric vehicle travels does not exceed the predetermined threshold value, in other words, when it is determined that the predicted temperature of the switching element does not exceed the predetermined value (“No” in Step S12), the control device 60 ends the process shown in the flow of FIG. 5.

On the other hand, in Step S12, when the gradient of the road surface on which the electric vehicle travels exceeds the predetermined threshold value, in other words, when it is determined that the predicted temperature of the switching element exceeds the predetermined value (“Yes” in Step S12), the process goes to a determination process of Step S13.

In Step S13, the frequency switching determination unit 63 determines whether or not the current traveling state of the electric vehicle coincides with the predetermined traveling pattern stored in the storage unit 62, on the basis of the data of the vehicle speed of the electric vehicle. When the current traveling state of the electric vehicle coincides with the predetermined traveling pattern, the frequency switching determination unit 63 determines whether or not it is a state where the driver can allow a noise, on the basis of the determination result on whether or not the driver can allow a generated sound, which is associated with the predetermined traveling pattern stored in the storage unit 62.

Further, the frequency switching determination unit 63 may determine whether or not it is a state where the driver can allow a noise by determining whether or not the vehicle speed of the electric vehicle exceeds the predetermined threshold value.

In Step S13, when the vehicle speed of the electric vehicle does not exceed the predetermined threshold value, in other words, when it is determined that it is not a state where the driver can allow a noise (“No” in Step S13), the control device 60 ends the process shown in the flow of FIG. 5.

On the other hand, in Step S13, when the vehicle speed of the electric vehicle exceeds the predetermined threshold value, in other words, when it is determined that it is a state where the driver can allow a noise (“Yes” in Step S13), the process goes to a process of Step S14.

In Step S14, the inverter control unit 64 outputs the command to reduce the drive frequency of the switching element included in the power converter 20 to the control circuit 23, on the basis of the determination result of the frequency switching determination unit 63. On the basis of this command, the control circuit 23 outputs the control signal to the drive circuit 22 and the drive circuit 22 outputs the drive signal obtained by reducing the drive frequency to the switching element, to thereby actually reduce the drive frequency of the switching element. Then, the process shown in the flow of FIG. 5 is ended.

Also in the control system 201 of the second preferred embodiment, the same effect as described in the first preferred embodiment can be produced.

Further, in the control system 201 of the second preferred embodiment, though the frequency switching determination unit 63 determines whether or not it is a state where the driver can allow a noise, on the basis of the data of the vehicle speed of the electric vehicle, this is only one exemplary case. The control system 201 may have a configuration, for example, where the data acquisition unit 61 acquires data of acceleration of the electric vehicle from an acceleration sensor provided inside the electric vehicle and the frequency switching determination unit 63 determines whether or not the acceleration of the electric vehicle exceeds a predetermined threshold value, to thereby determine whether or not it is a state where the driver can allow a noise. Also in the case of using the data of the acceleration, since it can be determined that the driver selects to acceleratingly climb the road when the acceleration of the electric vehicle exceeds the predetermined value, it can be determined that it is a state where the driver can allow a noise. In this case, there may be a configuration where the storage unit 62 stores therein the threshold value used for determining the acceleration and the frequency switching determination unit 63 determines whether or not the acceleration of the electric vehicle exceeds the threshold value stored in the storage unit 62.

Furthermore, in the control system 201 of the second preferred embodiment, though the frequency switching determination unit 63 makes a determination on whether or not it is predicted that the load of the electric vehicle will increase in the future, in other words, on whether or not it is predicted that the electric vehicle will enter the climbing road in the future, on the basis of the information on the gradient of the road surface on which the electric vehicle travels, which is included in the data on the scheduled travel route provided from the navigation device 53, this is only one exemplary case. The determination may be made, for example, on the basis of the gradient information provided from the navigation device 53 or on the basis of the gradient information obtained as a result obtained by the control device 60 analyzing the position information of the electric vehicle provided from the navigation device 53. In these cases, the data on the scheduled travel route means the gradient information or the position information of the electric vehicle.

Further, the scene where the load of the electric vehicle will increase in the future is not limited to the case where the electric vehicle enters a sharply climbing road. It is predicted that the load of the electric vehicle will be higher than the current load, for example, also in the scene where the travel route is changed from a general road in an urban area or the like to an expressway or a suburb. In this case, the frequency switching determination unit 63 may have a configuration to determine whether or not it is predicted that the load of the electric vehicle will increase in the future, on the basis of the information indicating that the travel route included in the data on the scheduled travel route provided from the navigation device 53 is changed to an expressway or a suburb.

### The Third Preferred Embodiment

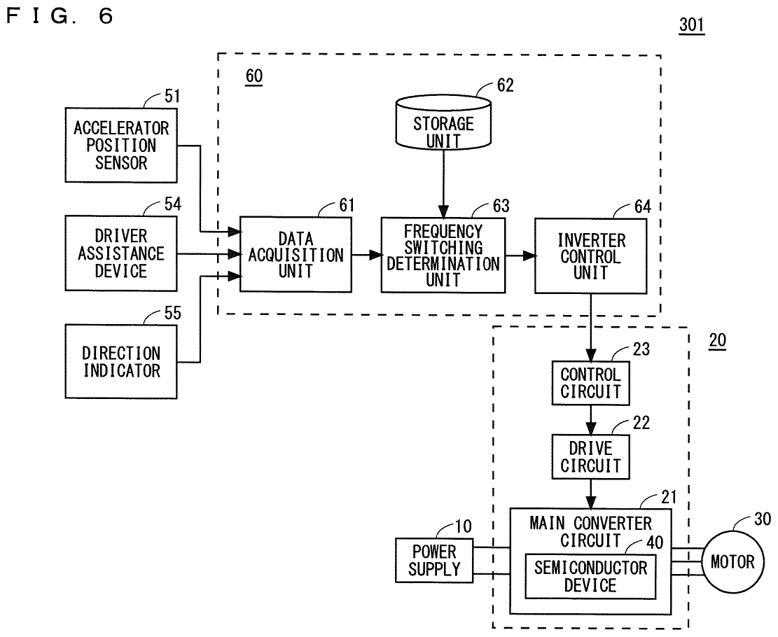

FIG. 6 is a block diagram showing an overall configuration of a control system 301 in accordance with the third preferred embodiment. The control system 301 of the third preferred embodiment is different from the control system 101 of the first preferred embodiment in that data acquired from a driver assistance device 54, the accelerator position sensor 51, and a direction indicator 55 are used, instead of the data acquired from the accelerator position sensor 51 and the vehicle speed sensor 52. Further, since the control system 301 of the third preferred embodiment is almost common to the control system 101 of the first preferred embodiment, description will be made below, centering on the difference with the control system 101, and description on the constituent elements, the operation, or the like common to those of the control system 101 will be omitted as appropriate.

As shown in FIG. 6, the control system 301 of the third preferred embodiment includes the power supply 10, the power converter 20, the motor 30, the semiconductor device 40, the accelerator position sensor 51, the driver assistance device 54, the direction indicator 55, and the control device 60.

The driver assistance device 54 is a device which performs an assistance of driving of the electric vehicle, such as an ACC (Adaptive Cruise Control), a self-driving device, or the like. The ACC has been developed on the premise of being used on an expressway or an automobile road, and is a device for automatically performing a driving operation to cause the electric vehicle to travel at a predetermined vehicle speed while keeping an inter-vehicle distance between the electric vehicle and another vehicle constant. In a conventional CC (Cruise Control), the driver can travel at a vehicle speed set by the driver but needs to perform a braking operation to keep the inter-vehicle distance constant. In contrast to this, the ACC can perform follow-up traveling which is traveling while keeping the inter-vehicle distance with a vehicle traveling in front of the self-vehicle constant by a cooperative operation between the sensor and the CPU, and has a configuration to automatically perform not only the accelerator operation but also the braking operation. This is said to be an autonomous driving level 2.

The accelerator position sensor 51 is the same one as described in the first preferred embodiment. The direction indicator 55 is a device operated by the driver to display a direction of right or left turning or change of course to others around the self-vehicle, which is referred to as a so-called blinker (winker).

Like the accelerator position sensor 51, the driver assistance device 54 and the direction indicator 55 are electrically connected to the control device 60. The driver assistance device 54 outputs data on a driving state of the electric vehicle to the control device 60. Further, the direction indicator 55 outputs data on a traveling direction of the electric vehicle to the control device 60.

Further, since the respective constitutions and operations of the driver assistance device 54 and the direction indicator 55 are publicly known, more detailed description thereof will be omitted.

In the third preferred embodiment, the data acquisition unit 61 of the control device 60 acquires data on the driving state of the electric vehicle from the driver assistance device 54. The data on the driving state of the electric vehicle include information indicating that the electric vehicle performs autonomous driving by using the ACC. Further, the data acquisition unit 61 acquires data on the traveling direction of the electric vehicle from the direction indicator 55. The data on the traveling direction of the electric vehicle include information indicating a direction in which the electric vehicle performs right or left turning or change of course. Furthermore, the data acquisition unit 61 acquires the data of the accelerator opening A of the electric vehicle from the accelerator position sensor 51, like in the first preferred embodiment.

In the third preferred embodiment, the storage unit 62 stores therein data obtained by associating the data on the driving state of the electric vehicle with a result obtained by determining in advance whether or not the driver can allow a sound generated from the power converter 20 in this driving state, for the driving state of the electric vehicle.

Further, in the third preferred embodiment, the storage unit 62 stores therein the prediction model used for predicting the future load of the motor 30 or the power converter 20 on the basis of the data on the traveling direction of the electric vehicle and the data of the accelerator opening A of the electric vehicle.

In the third preferred embodiment, the frequency switching determination unit 63 determines whether or not the current traveling state of the electric vehicle coincides with the predetermined traveling pattern stored in the storage unit 62, on the basis of the data of the driving state of the electric vehicle, and determines whether or not it is a state where the driver can allow a noise, on the basis of the determination result.

Further, in the third preferred embodiment, the frequency switching determination unit 63 determines whether or not it is a state where the driver can allow a noise by the acquired data indicating that the electric vehicle performs autonomous driving by using the ACC, which are included in the data on the driving state of the electric vehicle. When the electric vehicle performs autonomous driving by using the ACC, it can be determined that the electric vehicle is in a high-speed traveling state and the driver shows his will to allow a noise.

Further, in the third preferred embodiment, the frequency ng determination unit 63 predicts the future temperature of the switching element on the basis of the data on the traveling direction of the electric vehicle and the data of the accelerator opening A of the electric vehicle, and further the prediction model and the relational expression stored in the storage unit 62.

Further, in the third preferred embodiment, the frequency switching determination unit 63 predicts the future temperature of the switching element and determines whether or not the predicted temperature of the switching element exceeds the predetermined value, on the basis of the information indicating the direction in which the electric vehicle performs right or left turning or change of course, which is included in the data on the traveling direction of the electric vehicle, and the accelerator opening A of the electric vehicle. In the state where the electric vehicle performs autonomous driving by using the ACC, when the accelerator operation and a blinker (winker) operation are detected, since it can be determined that overtaking acceleration will be performed by the driver's will, it can be predicted that a high load will be applied to the switching element and the temperature thereof will rise at this stage. In this case, there may be a configuration where the storage unit 62 stores therein the threshold value used for determining the accelerator opening A and the frequency switching determination unit 63 acquires information indicating that the electric vehicle will perform right or left turning or change of course, from the direction indicator 55, and determines whether or not the accelerator opening A exceeds the threshold value stored in the storage unit 62.

When the frequency switching determination unit 63 determines that it is a state where the driver can allow a noise and the predicted temperature of the switching element exceeds the predetermined value, the inverter control unit 64 outputs the command to reduce the drive frequency of the switching element included in the power converter 20 to the control circuit 23. In other words, when the inverter control unit 64 determines that it is a state where the driver assistance device 54 performs driver assistance of the electric vehicle and that the driver will make overtaking (passing), on the basis of the data of the accelerator opening A of the electric vehicle and the data on the traveling direction of the electric vehicle, the inverter control unit 64 reduces the drive frequency of the switching element.

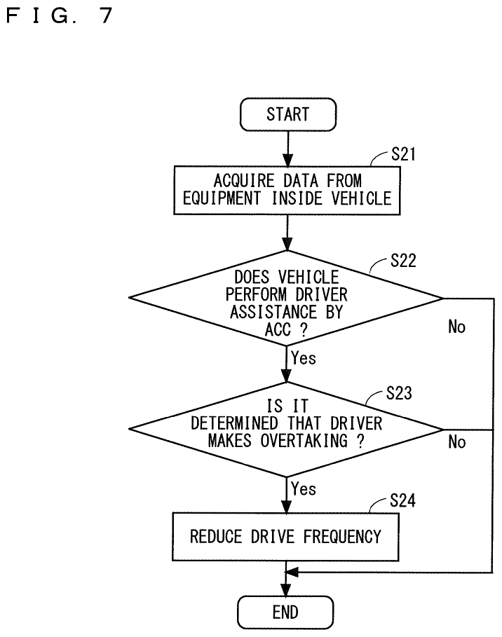

FIG. 7 is a flowchart showing an operation of the control device 60 in accordance with the third preferred embodiment. In Step S21, the data acquisition unit 61 acquires the data on the driving state of the electric vehicle from the driver assistance device 54, acquires the data of the traveling direction of the electric vehicle from the direction indicator 55, and acquires the data of the accelerator opening A of the electric vehicle from the accelerator position sensor 51.

In Step S22, the frequency switching determination unit 63 determines whether or not the current traveling state of the electric vehicle coincides with the predetermined traveling pattern stored in the storage unit 62, on the basis of the data on the driving state of the electric vehicle. When the current traveling state of the electric vehicle coincides with the predetermined traveling pattern, the frequency switching determination unit 63 determines whether or not it is a state where the driver can allow a noise, on the basis of the determination result on whether or not the driver can allow a generated sound, which is associated with the predetermined traveling pattern stored in the storage unit 62.

Further, the frequency switching determination unit 63 may determine whether or not it is a state where the driver can allow a noise by acquiring the information indicating that the electric vehicle performs autonomous driving by using the ACC, which is included in the data on the driving state of the electric vehicle.

In Step S22, when the information indicating that the electric vehicle performs autonomous driving by using the ACC is not acquired, in other words, when it is determined that it is not a state where the driver can allow a noise (“No” in Step S22), the control device ends the process shown in the flow of FIG. 7.

On the other hand, in Step S22, when the information indicating that the electric vehicle performs autonomous driving by using the ACC is acquired, in other words, when it is determined that it is a state where the driver can allow a noise (“Yes” in Step S22), the process goes to a determination process of Step S23.

In Step S23, the frequency switching determination unit 63 predicts the future temperature of the switching element and determines whether or not the predicted temperature exceeds the predetermined value, on the basis of the data on the traveling direction of the electric vehicle and the data of the accelerator opening A of the electric vehicle, the prediction model used for predicting the future load of the motor 30 or the power converter 20 which is stored in the storage unit 62, and the relational expression used for obtaining the temperature of the switching element on the basis of the load of the motor or the power converter 20 and the characteristics of the switching element which are stored in the storage unit 62.

Further, the frequency switching determination unit 63 may determine whether or not the predicted temperature of the switching element exceeds the predetermined value by acquiring the information indicating that the electric vehicle performs right or left turning or change of course and determining whether or not the accelerator opening A exceeds the predetermined threshold value.

In Step S23, when the information indicating that the electric vehicle performs right or left turning or change of course is not acquired, or when the accelerator opening A does not exceed the predetermined threshold value, in other words, when it is determined that the predicted temperature of the switching element does not exceed the predetermined value (“No” in Step S23), the control device 60 ends the process shown in the flow of FIG. 7.

On the other hand, in Step S23, when the information indicating that the electric vehicle performs right or left turning or change of course is acquired and the accelerator opening A exceeds the predetermined threshold value, in other words, when it is determined that the predicted temperature of the switching element exceeds the predetermined value (“Yes” in Step S23), the process goes to a process of Step S24.

In Step S24, the inverter control unit 64 outputs the command to reduce the drive frequency of the switching element included in the power converter 20 to the control circuit 23, on the basis of the determination result of the frequency switching determination unit 63. On the basis of this command, the control circuit 23 outputs the control signal to the drive circuit 22 and the drive circuit 22 outputs the drive signal obtained by reducing the drive frequency to the switching element, to thereby actually reduce the drive frequency of the switching element. Then, the process shown in the flow of FIG. 7 is ended.

Also in the control system 301 of the third preferred embodiment, the same effect as described in the first preferred embodiment can be produced.

Further, in the control system 301 of the third preferred embodiment, though the inverter control unit 64 reduces the drive frequency of the switching element when the inverter control unit 64 determines that it is a state where the driver assistance device 54 performs driver assistance of the electric vehicle and that the driver will make overtaking, on the basis of the data of the accelerator opening A of the electric vehicle and the data on the traveling direction of the electric vehicle, this is only one exemplary case. There may be a case, for example, where the driver assistance device 54 is a device for automatically performing a driving operation including overtaking and when the driver assistance device 54 makes overtaking, the inverter control unit 64 reduces the drive frequency of the switching element.

In this case, for example, the driver assistance device 54 may be a device for performing driver assistance of the electric vehicle so that the electric vehicle automatically travels while keeping an inter-vehicle distance with a vehicle traveling in front thereof constant at a maximum of the set speed on a predetermined travel route such as an expressway or the like in conjunction with the navigation device. In a case where a vehicle travels in front of the self-vehicle at a speed lower than the set speed, when the driver assistance device 54 determines that the self-vehicle can overtake the vehicle, the driver assistance device 54 proposes the driver to overtake the vehicle. Then, when the driver accepts the proposition with a switch operation or the like, the driver assistance device 54 can automatically perform a series of operations from lane change, then overtaking of the vehicle in front, to return to the original lane.

Further, the driver assistance device 54 is electrically connected to the control device 60 and outputs the data on the driving state of the electric vehicle to the control device 60. The data acquisition unit 61 acquires the data on the driving state of the electric vehicle from the driver assistance device 54. The data on the driving state of the electric vehicle include information indicating that the driver assistance device 54 automatically makes overtaking.

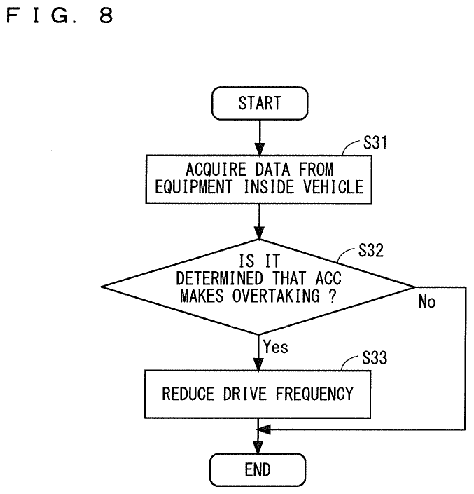

FIG. 8 is a flowchart showing an operation of the control device 60 in accordance with a variation of the third preferred embodiment. In Step S31, the data acquisition unit 61 acquires the data on the driving state of the electric vehicle from the driver assistance device 54.

In Step S32, the frequency switching determination unit 63 determines whether or not the current traveling state of the electric vehicle coincides with the predetermined traveling pattern stored in the storage unit 62, on the basis of the data on the driving state of the electric vehicle. When the current traveling state of the electric vehicle coincides with the predetermined traveling pattern, the frequency switching determination unit 63 determines whether or not it is a state where the driver can allow a noise, on the basis of the determination result on whether or not the driver can allow a generated sound, which is associated with the predetermined traveling pattern stored in the storage unit 62.

Further, the frequency switching determination unit 63 predicts the future temperature of the switching element and determines whether or not the predicted temperature exceeds the predetermined value, on the basis of the data on the driving state of the electric vehicle, the prediction model used for predicting the future load of the motor 30 or the power converter 20 which is stored in the storage unit 62, and the relational expression used for obtaining the temperature of the switching element on the basis of the load of the motor 30 or the power converter 20 and the characteristics of the switching element which are stored in the storage unit 62.

Furthermore, the frequency switching determination unit 63 may determine whether or not it is a state where the driver can allow a noise by acquiring the information indicating that the driver assistance device 54 automatically makes overtaking, which is included in the data on the driving state of the electric vehicle. Further, the frequency switching determination unit 63 may determine whether or not the predicted temperature of the switching element exceeds the predetermined value by acquiring the information indicating that the driver assistance device 54 automatically makes overtaking, which is included in the data on the driving state of the electric vehicle. In other words, the frequency switching determination unit 63 may have a configuration to perform these determinations together at a time by acquiring the information indicating that the driver assistance device 54 automatically makes overtaking.

In Step S32, when the information indicating that the driver assistance device 54 automatically makes overtaking is not acquired, in other words, when it is determined that it is not a state where the driver can allow a noise or that the predicted temperature of the switching element does not exceed the predetermined value (“No” in Step S32), the control device 60 ends the process shown in the flow of FIG. 8.

On the other hand, in Step S32, when the information indicating that the driver assistance device 54 automatically makes overtaking is acquired, in other words, when it is determined that it is a state where the driver can allow a noise and that the predicted temperature of the switching element exceeds the predetermined value (“Yes” in Step S32), the process goes to a process of Step S33.

In Step S33, the inverter control unit 64 outputs the command to reduce the drive frequency of the switching element included in the power converter 20 to the control circuit 23, on the basis of the determination result of the frequency switching determination unit 63. On the basis of this command, the control circuit 23 outputs the control signal to the drive circuit 22 and the drive circuit 22 outputs the drive signal obtained by reducing the drive frequency to the switching element, to thereby actually reduce the drive frequency of the switching element. Then, the process shown in the flow of FIG. 8 is ended.

Also in the variation of the third preferred embodiment, the same effect as described in the first preferred embodiment can be produced.

Further, in the variation of the third preferred embodiment, since the drive frequency of the switching element can be reduced without waiting the data acquired from the direction indicator 55 and the accelerator position sensor 51, it is possible to increase the effect of suppressing the heat generation of the switching element and improving the drive efficiency thereof, and possible to simplify the processing performed by the control device 60.

### The Fourth Preferred Embodiment

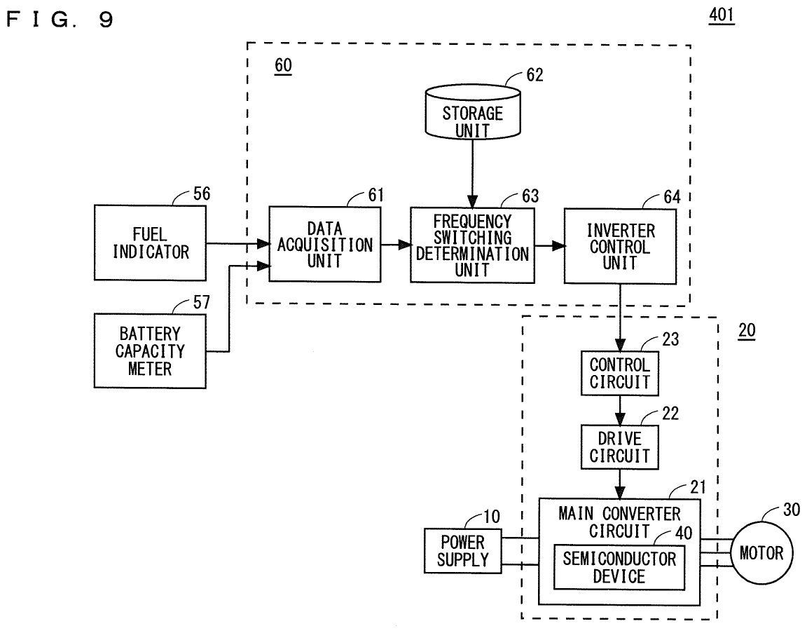

FIG. 9 is a block diagram showing an overall configuration of a control system 401 in accordance with the fourth preferred embodiment. The control system 401 of the fourth preferred embodiment is different from the control system 101 of the first preferred embodiment in that data acquired from a fuel indicator 56 and data acquired from a battery capacity meter 57 are used, instead of the data acquired from the accelerator position sensor 51 and the data acquired from the vehicle speed sensor 52. Further, since the control system 401 of the fourth preferred embodiment is almost common to the control system 101 of the first preferred embodiment, description will be made below, centering on the difference with the control system 101, and description on the constituent elements, the operation, or the like common to those of the control system 101 will be omitted as appropriate.

In the fourth preferred embodiment, the electric vehicle on which the control system 401 is mounted is a hybrid vehicle on which both a gasoline engine and a battery are mounted. Further, the control device 60 determines whether or not it is a state where the driver can allow a noise, on the basis of a cruising range where the hybrid vehicle can travel in the future.

As shown in FIG. 9, the control system 401 of the fourth preferred embodiment includes the power supply 10, the power converter 20, the motor 30, the semiconductor device 40, the fuel indicator 56, the battery capacity meter 57, and the control device 60.

The fuel indicator 56 is a measuring instrument for detecting the remaining amount of fuel of the gasoline engine or the like in the hybrid vehicle and displaying the remaining amount to the driver. The fuel indicator 56 is used mainly so that the driver can grasp the current remaining amount of fuel.

The battery capacity meter 57 is a sensor configured to detect the remaining capacity of the not-shown battery mounted on the hybrid vehicle, i.e., the SOC (State Of Charge). Further, the battery is a rechargeable storage battery, serving as a power supply source for supplying power to drive the motor 30.

The fuel indicator 56 and the battery capacity meter 57 are electrically connected to the control device 60, and the remaining amount of fuel of the hybrid vehicle which is detected by the fuel indicator 56 and the battery remaining capacity detected by the battery capacity meter 57 are always grasped by the control device 60.

Further, since the respective constitutions and operations of the fuel indicator 56 and the battery capacity meter 57 are publicly known, more detailed description thereof will be omitted.

In the fourth preferred embodiment, the data acquisition unit 61 of the control device 60 acquires data of the remaining amount of fuel of the hybrid vehicle from the fuel indicator 56 and acquires data of the battery remaining capacity of the hybrid vehicle from the battery capacity meter 57.

In the fourth preferred embodiment, the storage unit 62 stores therein a model used for determining whether or not it is a state where the driver can allow a noise, on the basis of the data of the remaining amount of fuel of the hybrid vehicle and the data of the battery remaining capacity of the hybrid vehicle.

In the fourth preferred embodiment, the frequency switching determination unit 63 determines whether or not it is a state where the driver can allow a noise, on the basis of the data of the remaining amount of fuel of the hybrid vehicle and the data of the battery remaining capacity of the hybrid vehicle, and the model stored in the storage unit 62.

Further, in the fourth preferred embodiment, the frequency switching determination unit 63 may have a configuration to determine whether or not it is a state where the driver can allow a noise by determining whether or not the remaining amount of fuel of the hybrid vehicle falls below a predetermined threshold value. Furthermore, the frequency switching determination unit 63 may have a configuration to determine whether or not it is a state where the driver can allow a noise by determining whether or not the battery remaining capacity falls below a predetermined threshold value. When the remaining amount of fuel or the battery remaining capacity falls below the predetermined threshold value, it can be determined that the vehicle is short of fuel or battery capacity and it is a condition where the driver wants an extension of the cruising range. In other words, since it is a state where the loss is preferentially prevented from increasing due to the high load of the switching element, it can be determined that it is a state where the driver can allow a noise. In this case, there may be a configuration where the storage unit 62 stores therein the respective threshold values used for determining the remaining amount of fuel and the battery remaining capacity of the hybrid vehicle and the frequency switching determination unit 63 determines whether or not the remaining amount of fuel or the battery remaining capacity of the hybrid vehicle exceeds the threshold value thereof stored in the storage unit 62.

Herein, the state where the remaining amount of fuel falls below the predetermined threshold value refers to, for example, a stage where the fuel indicator lights up a low fuel warning indicator such as a warning light or the like when the remaining amount of fuel detected by the fuel indicator becomes low, to urge the driver to quickly refuel the vehicle. The warning light is lit when the height of the float in a gas tank is detected by a sensor or a switch and the detected value exceeds a predetermined value. Further, the timing when the warning light is lit is generally a stage where the distance that the vehicle can travel with the fuel remaining in the gas tank becomes about 10 km to 5 km.

Furthermore, the same applies to the state where the battery remaining capacity falls below the predetermined threshold value, and the state refers to a stage where a low battery warning indicator such as a warning light or the like is lit up when the remaining cruising range calculated from the SOC becomes low. Further, the state where the remaining amount of fuel or the battery remaining capacity falls below the predetermined threshold value is not limited to the above-described state, but there may be a configuration where when it is predicted that the vehicle will be short of fuel or battery capacity in the future, it is determined in advance that the vehicle will be short of fuel or battery capacity in the future in a stage earlier than the stage where the warning light is lit up.

Like in the first preferred embodiment, when the frequency switching determination unit 63 determines that it is a state where the driver can allow a noise, the inverter control unit 64 outputs the command to reduce the drive frequency of the switching element included in the power converter 20 to the control circuit 23. In other words, when the remaining amount of fuel or the battery remaining capacity of the hybrid vehicle falls below the predetermined value, the inverter control unit 64 reduces the drive frequency of the switching element.

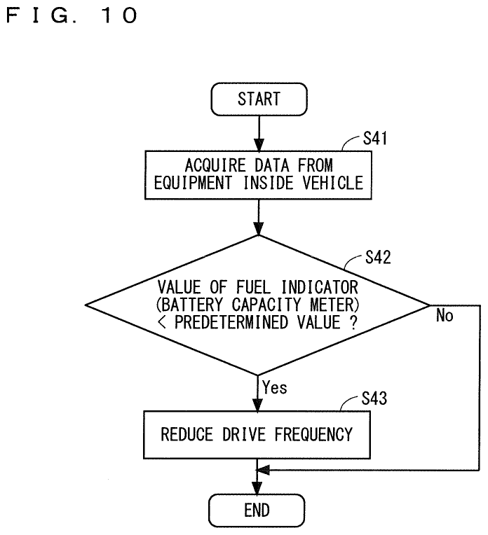

FIG. 10 is a flowchart showing an operation of the control device 60 in accordance with the fourth preferred embodiment. In Step S41, the data acquisition unit 61 acquires the data of the remaining amount of fuel of the hybrid vehicle from the fuel indicator 56 and acquires the data of the battery remaining capacity of the hybrid vehicle from the battery capacity meter 57.

In Step S42, the frequency switching determination unit 63 determines whether or not it is a state where the driver can allow a noise, on the basis of the data of the remaining amount of fuel of the hybrid vehicle and the data of the battery remaining capacity of the hybrid vehicle, and the model stored in the storage unit 62.

Further, the frequency switching determination unit 63 may have a configuration to determine whether or not it is a state where the driver can allow a noise by determining whether or not the remaining amount of fuel of the hybrid vehicle falls below the predetermined threshold value. Furthermore, the frequency switching determination unit 63 may have a configuration to determine whether or not it is a state where the driver can allow a noise by determining whether or not the battery remaining capacity falls below the predetermined threshold value.

In Step S42, when the remaining amount of fuel of the hybrid vehicle does not fall below the predetermined threshold value and the battery remaining capacity does not fall below the predetermined threshold value, in other words, when it is determined that it is not a state where the driver can allow a noise (“No” in Step S42), the control device 60 ends the process shown in the flow of FIG. 10.

On the other hand, in Step S42, when the remaining amount of fuel of the hybrid vehicle falls below the predetermined threshold value or the battery remaining capacity falls below the predetermined threshold value, in other words, when it is determined that it is a state where the driver can allow a noise (“Yes” in Step S42), the process goes to a process of Step S43.

In Step S43, the inverter control unit 64 outputs the command to reduce the drive frequency of the switching element included in the power converter 20 to the control circuit 23, on the basis of the determination result of the frequency switching determination unit 63. On the basis of this command, the control circuit 23 outputs the control signal to the drive circuit 22 and the drive circuit 22 outputs the drive signal obtained by reducing the drive frequency to the switching element, to thereby actually reduce the drive frequency of the switching element. Then, the process shown in the flow of FIG. 10 is ended.

Also in the control system 401 of the fourth preferred embodiment, the same effect as described in the first preferred embodiment can be produced.

Further, as described above, it is possible to suppress the heat generation and the loss of the switching element by reducing the drive frequency of the switching element. For this reason, it is possible to avoid the loss from increasing due to the high load of the switching element by reducing the drive frequency in the stage where the remaining amount of fuel or the battery remaining capacity becomes low, and this produces an effect to increase the utilization efficiency of fuel or battery and extend the cruising range of the hybrid vehicle. In other words, according to the control system 401 of the fourth preferred embodiment, it is possible to ensure both the drivability of the driver and the safety of the device and also possible to ensure improvement in the cruising range.

Furthermore, in the fourth preferred embodiment, though the electric vehicle on which the control system 401 is mounted is a hybrid vehicle on which both the gasoline engine and the battery are mounted, this is only one exemplary case. The electric vehicle may be, for example, an electric vehicle on which only a battery such as a lead battery, a nickel metal hydride battery, a lithium ion battery, or the like is mounted, a fuel cell vehicle on which a battery as a fuel battery using hydrogen fuel is mounted, or the like. In this case, the data acquisition unit 61 acquires the data of the battery remaining capacity from only the battery capacity meter, the frequency switching determination unit 63 determines whether or not it is a state where the driver can allow a noise, on the basis of the data of the battery remaining capacity, and the inverter control unit 64 reduces the drive frequency of the switching element included in the power converter 20 on the basis of the determination result of the frequency switching determination unit 63. Such a configuration can produce the same effect as described above.

### The Fifth Preferred Embodiment

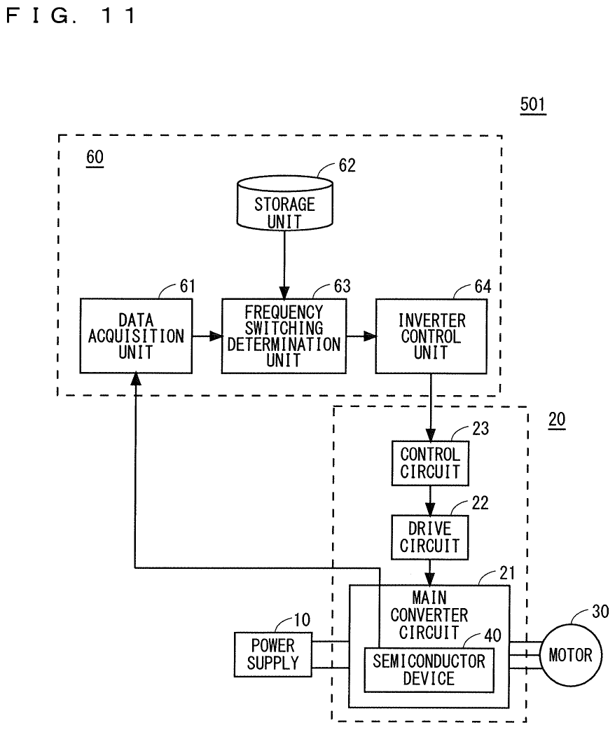

FIG. 11 is a block diagram showing an overall configuration of a control system 501 in accordance with the fifth preferred embodiment. The control system 501 of the fifth preferred embodiment is different from the control system 101 of the first preferred embodiment in that data acquired from a temperature sensor 42 and data acquired from a current sensor 43 are used, instead of the data acquired from the accelerator position sensor 51 and the data acquired from the vehicle speed sensor 52. Further, since the control system 501 of the fifth preferred embodiment is almost common to the control system 101 of the first preferred embodiment, description will be made below, centering on the difference with the control system 101, and description on the constituent elements, the operation, or the like common to those of the control system 101 will be omitted as appropriate.

As shown in FIG. 11, the control system 501 of the fifth preferred embodiment includes the power supply 10, the power converter 20, the motor 30, the semiconductor device 40, and the control device 60. The control device 60 is electrically connected to the semiconductor device 40 and has a configuration to transmit and receive data thereto/therefrom.

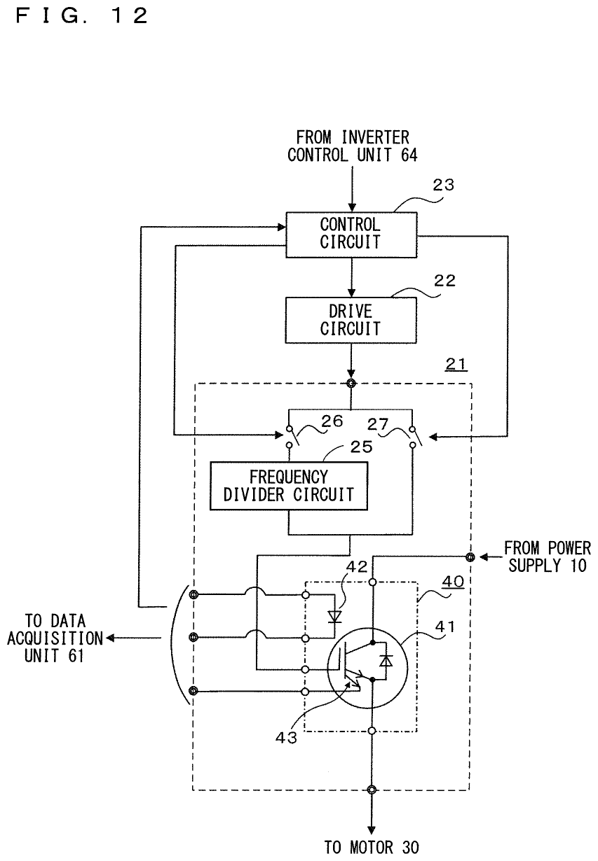

FIG. 12 is a schematic view showing a configuration of the power converter 20 in accordance with the fifth preferred embodiment. As shown in FIG. 12, the semiconductor device 40 includes a switching element 41, the temperature sensor 42, and the current sensor 43.

The temperature sensor 42 detects an element temperature Ts of the switching element 41. In the fifth preferred embodiment, the temperature sensor 42 is an on-chip temperature sensor provided inside a chip of the switching element 41. Further, the temperature sensor 42 is not limited to one provided inside the chip of the switching element 41, but has only to be provided in the main converter circuit 21 and configured to measure the element temperature Ts of the switching element 41. As the temperature sensor 42, for example, a temperature sensor incorporated in the semiconductor device 40 which is formed as an intelligent power module (IPM) can be used.

The current sensor 43 detects a value of current Is flowing in the switching element 41, In the fifth preferred embodiment, the current sensor 43 is an on-chip current sensor for detecting the value of current Is flowing in a current sense region arranged inside a chip of the switching element 41. Further, the current sensor 43 is not limited to one provided inside the chip of the switching element 41, but has only to be provided in the main converter circuit 21 and configured to measure the value of current Is flowing in the switching element 41. The current sensor 43 can have a configuration to detect the value of current Is flowing in the switching element 41 by using a not-shown shunt resistor connected to the inside or the outside of the semiconductor device 40.

The temperature sensor 42 and the current sensor 43 are electrically connected to the control device 60, and the element temperature Ts of the switching element 41 which is detected by the temperature sensor 42 and the value of current Is flowing in the switching element 41 which is detected by the current sensor 43 are always grasped by the control device 60.

Further, since the respective constitutions and operations of the temperature sensor 42 and the current sensor 43 are publicly known, more detailed description thereof will be omitted.

As shown in FIG. 12, the main converter circuit 21 includes the semiconductor device 40, a frequency divider circuit 25, a switch 26, and a switch 27. The frequency divider circuit 25 divides a frequency of the drive signal inputted from the drive circuit 22 and outputs the divided frequencies. As the frequency divider circuit 25, for example, a ½ frequency divider circuit for dividing the frequency of the inputted drive signal into ½ or a ⅓ frequency divider circuit for dividing the frequency of the inputted drive signal into ⅓ can be used. The switch 26 and the switch 27 open and close in response to the command from the control circuit 23, and switch between a path in which the drive signal from the drive circuit 22 is once carried to the frequency divider circuit 25 and then supplied to the switching element 41 and another path in which the drive signal is directly supplied to the switching element 41. At a normal time, the switch 26 is in an open state and the switch 27 is in a closed state, and the drive signal from the drive circuit 22 is directly supplied to the control electrode of the switching element 41.

In the power converter 20 of the fifth preferred embodiment, by adopting a configuration where the frequency divider circuit 25 provided in the main converter circuit 21 divides the frequency of the drive signal, it is possible to prevent occurrence of a delay in the process in which the control device 60 detects an abnormality and performs a control process to output a command to switch the drive frequency and in response to this command, the operation of the switching element 41 is actually switched. It is thereby possible to prevent any trouble such as deterioration of the switching element 41 due to a rise in the temperature of the switching element 41 during a delay time of the processing delay, or the like. Further, since the constitution and operation of the frequency divider circuit 25 are publicly known, as disclosed in, for example, Japanese Patent Application Laid Open Gazette No. 6-140923, more detailed description thereof will be omitted.

To the control circuit 23, inputted are data of the element temperature Ts of the switching element 41 from the temperature sensor 42 and data of the value of current Is flowing in the switching element 41 from the current sensor 43. Further, predetermined threshold values are set in the control circuit 23, and when the element temperature Ts of the switching element 41 and the amount of variation Hs/tit in the element temperature exceed the respective threshold values, the control circuit 23 outputs a command to switch between the open state and the closed state of the switches 26 and 27. The drive signal of the drive circuit 22 is thereby supplied to the control electrode of the switching element 41 through the frequency divider circuit 25.

In the fifth preferred embodiment, the control device 60 determines whether or not it is a state where the driver can allow a noise, on the basis of the element temperature Ts of the switching element 41 and the amount of variation dTs/dt in the temperature. In the fifth preferred embodiment, the data acquisition unit 61 of the control device 60 acquires the data of the element temperature Ts of the switching element 41 from the temperature sensor 42.

In the fifth preferred embodiment, the storage unit 62 stores therein a prediction model used for predicting whether or not there is a risk that the temperature of the switching element 41 becomes high in the future on the basis of the data of the element temperature Ts of the switching element 41. Herein, as described above, the heatproof temperature of a silicon semiconductor is generally 150° C. and usually a guaranteed operating temperature is specified for a used semiconductor, and in contrast to this, it is general to make a control to perform a switching process at about 100° C. in consideration of a sensor error and a delay in processing time on the system side. The temperature at which the switching process is performed is set from a response of a system which performs switching control, or the like, and in a case of slow response system, the temperature is set to be low, and in the converse case, the temperature is set to a value near 150° C. The slow response system refers to, for example, a case where there is a lot of noise and a filter time constant used for filtering a signal is slow, a case where an operation timing of a microcomputer is slow, or the like case.

It is preferable that the prediction model stored in the storage unit 62 should be created in consideration of the above-described circumstances. Further, the prediction model or the threshold value may be set experimentally, empirically, or on the basis of a simulation or the like.

Furthermore, in the fifth preferred embodiment, the storage unit 62 stores therein a model used for determining whether or not it is a state where the driver can allow a noise, on the basis of the data of the amount of variation dTs/dt in the element temperature of the switching element 41. Further, the method of associating the amount of variation dTs/dt in the element temperature of the switching element 41 with whether or not the driver can allow a sound generated at that time can be determined in the same way as described in the first preferred embodiment. Specifically, on the basis of results of test run in a development of the electric vehicle and a simulation in which the electric vehicle is simulated, modeling is made by calculating a relation between the amount of variation dTs/dt in the element temperature and the specified temperature such as the guaranteed operating temperature of a semiconductor, or the like.

In the fifth preferred embodiment, the frequency switching determination unit 63 predicts that the load of the electric vehicle will increase in the future and predicts the temperature of the switching element at that time, on the basis of the data of the element temperature Ts of the switching element 41 and the prediction model stored in the storage unit 62.

Further, there may be a configuration where the storage unit 62 stores therein the threshold value used for determining the element temperature Ts and the frequency switching determination unit 63 determines whether or not the element temperature Ts of the switching element 41 exceeds the threshold value stored in the storage unit 62, to thereby determine whether or not the predicted temperature of the switching element exceeds a predetermined value.

Then, in the fifth preferred embodiment, when the predicted temperature of the switching element exceeds the predetermined value, the frequency switching determination unit 63 determines whether or not it is a state where the driver can allow a noise, on the basis of the amount of variation dTs/dt in the element temperature of the switching element 41 which is calculated from the data of the element temperature Ts of the switching element 41 and the model stored in the storage unit 62.

Further, in the fifth preferred embodiment, the frequency switching determination unit 63 may have a configuration to determine whether or not it is a state where the driver can allow a noise by determining whether or not the amount of variation dTs/dt in the element temperature of the switching element 41 exceeds the predetermined threshold value. When the amount of variation dTs/dt in the element temperature of the switching element 41 exceeds the predetermined threshold value, it can be determined that there occurs a large load change in the electric vehicle and it becomes a high-load driving state where the driver can allow a noise. In this case, there may be a configuration where the storage unit 62 stores therein the threshold value used for determining the amount of variation dTs/dt in the element temperature and the frequency switching determination unit 63 calculates the amount of variation dTs/dt in the element temperature from the data of the element temperature Ts of the switching element 41 and determines whether or not the calculated amount of variation dTs/dt in the element temperature exceeds the threshold value stored in the storage unit 62.

Like in the first preferred embodiment, when the frequency switching determination unit 63 determines that it is a state where the driver can allow a noise, the inverter control unit 64 outputs the command to reduce the drive frequency of the switching element included in the power converter 20 to the control circuit 23. In other words, when the element temperature Ts of the switching element 41 exceeds the predetermined value and the amount of variation dTs/dt in the element temperature of the switching element 41 exceeds the predetermined value, the inverter control unit 64 reduces the drive frequency of the switching element 41.

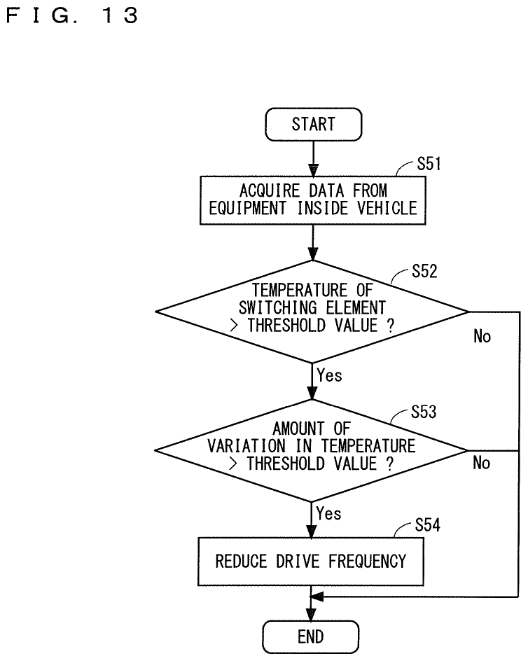

FIG. 13 is a flowchart showing an operation of the control device 60 in accordance with the fifth preferred embodiment. In Step S51, the data acquisition unit 61 acquires the data of the element temperature Ts of the switching element 41 from the temperature sensor 42.

In Step S52, the frequency switching determination unit 63 predicts the future temperature of the switching element and determines whether or not the predicted temperature exceeds the predetermined value, on the basis of the data of the element temperature Ts of the switching element 41 from the temperature sensor 42 and the prediction model used for predicting whether or not there is a risk that the temperature of the switching element 41 will become high in the future.

Further, the frequency switching determination unit 63 may determine whether or not the predicted temperature of the switching element exceeds the predetermined value by determining whether or not the element temperature Ts of the switching element 41 exceeds the predetermined threshold value.

In Step S52, when the element temperature Ts of the switching element 41 does not exceed the predetermined threshold value, in other words, when it is determined that the predicted temperature of the switching element does not exceed the predetermined value (“No” in Step S52), the control device 60 ends the process shown in the flow of FIG. 13.

On the other hand, in Step S52, when the element temperature Ts of the switching element 41 exceeds the predetermined threshold value, in other words, when it is determined that the predicted temperature of the switching element exceeds the predetermined value (“Yes” in Step S52), the process goes to a determination process of Step S53.

In Step S53, the frequency switching determination unit 63 determines whether or not it is a state where the driver can allow a noise, on the basis of the amount of variation dTs/dt in the element temperature of the switching element 41 which is calculated from the data of the element temperature Ts of the switching element 41 and the model stored in the storage unit 62.

Further, the frequency switching determination unit 63 may determine whether or not it is a state where the driver can allow a noise by determining whether or not the amount of variation dTs/dt in the element temperature which is calculated from the data of the element temperature Ts of the switching element 41 exceeds the threshold value stored in the storage unit 62.

In Step S53, when the vehicle speed of the electric vehicle does not exceed the predetermined threshold value, in other words, when it is determined that it is not a state where the driver can allow a noise (“No” in Step S53), the control device 60 ends the process shown in the flow of FIG. 13.

On the other hand, in Step S53, when the vehicle speed of the electric vehicle exceeds the predetermined threshold value, in other words, when it is determined that it is a state where the driver can allow a noise (“Yes” in Step S53), the process goes to a process of Step S54.

In Step S54, the inverter control unit 64 outputs the command to reduce the drive frequency of the switching element 41 included in the power converter 20 to the control circuit 23, on the basis of the determination result of the frequency switching determination unit 63. On the basis of this command, the control circuit 23 outputs the control signal to the drive circuit 22 and the drive circuit 22 outputs the drive signal obtained by reducing the drive frequency to the switching element, to thereby actually reduce the drive frequency of the switching element. Then, the process shown in the flow of FIG. 13 is ended.

Further, when the inverter control unit 64 reduces the drive frequency of the switching element 41, the power converter 20 of the fifth preferred embodiment outputs the command to reduce the drive frequency of the switching element 41 to the control circuit 23, and at the same time or before that, the power converter 20 of the fifth preferred embodiment divides the frequency of the drive signal used for driving the switching element 41. In other words, in the fifth preferred embodiment, the data of the element temperature Ts of the switching element 41 which is detected by the temperature sensor 42 is supplied also to the control circuit 23 in the stage of Step S51. Then, when the element temperature Ts of the switching element 41 exceeds the predetermined threshold value and the amount of variation dTs/dt in the element temperature exceeds the predetermined threshold value, the control circuit 23 outputs the command to switch between the open state and the closed state of the switches 26 and 27. The drive signal of the drive circuit 22 thereby goes through the frequency divider circuit 25, where the frequency thereof is divided, and the frequency-divided drive signal is supplied to the control electrode of the switching element 41.

Also in the control system 501 of the fifth preferred embodiment, the same effect as described in the first preferred embodiment can be produced.

Further, in the stage of Step S51, when the element temperature Ts of the switching element 41 and the amount of variation dTs/dt in the element temperature exceed the respective predetermined threshold values, the control system 501 of the fifth preferred embodiment divides the frequency of the drive signal to be supplied to the switching element 41 by using the frequency divider circuit 25. It is thereby possible to prevent occurrence of a delay in the process in which the control device 60 detects an abnormality and performs the control process to output the command to switch the drive frequency and in response to this command, the operation of the switching element 41 is actually switched. Therefore, it is thereby possible to prevent any trouble such as deterioration of the switching element 41 due to a rise in the temperature of the switching element 41 during a delay time of the processing delay, or the like.

Further, in the fifth preferred embodiment, though the control system 501 reduces the drive frequency of the switching element 41 on the basis of the data of the element temperature Ts of the switching element 41 which are acquired from the temperature sensor 42, this is only one exemplary case. For example, the control system 501 may reduce the drive frequency of the switching element 41 on the basis of the value of current Is flowing in the switching element 41, which is acquired from the current sensor 43.

In this case, the data acquisition unit 61 acquires the data of the value of current Is flowing in the switching element 41 from the current sensor 43. The storage unit 62 stores therein the prediction model or the like or the threshold value used for determining the current value Is and a model or the like or a threshold value used for determining the amount of variation dIs/dt in the current value. The frequency switching determination unit 63 determines whether or not the predicted temperature of the switching element exceeds a predetermined value, on the basis of the current value Is and the prediction model or the like or the threshold value. Further, the frequency switching determination unit 63 determines whether or not it is a state where the driver can allow a noise, on the basis of the amount of variation dIs/dt in the current value and the model or the like or the threshold value. When the current value Is of the switching element 41 exceeds the predetermined value and the amount of variation dIs/dt in the current value exceeds the predetermined value, the inverter control unit 64 reduces the drive frequency of the switching element 41.

The element temperature Ts of the switching element 41 rises due to the heat generation accompanying the switching operation for performing power conversion. For this reason, the amount of variation dTs/dt in the element temperature mainly depends on the magnitude of a current to be switched by the switching element 41, i.e., the magnitude of an element current passing the switching element 41. Therefore, it is possible to predict the element temperature Ts of the switching element 41 from the value of current Is flowing in the switching element 41 and predict the amount of variation dTs/dt in the element temperature from the amount of variation dIs/dt in the current value. Accordingly, determining whether or not it is a state where the driver can allow a noise on the basis of the value of current Is flowing in the switching element 41 and the amount of variation dIs/dt in the current value has the same meaning as determining whether or not it is a state where the driver can allow a noise on the basis of the element temperature Ts of the switching element 41 and the amount of variation dTs/dt in the temperature.

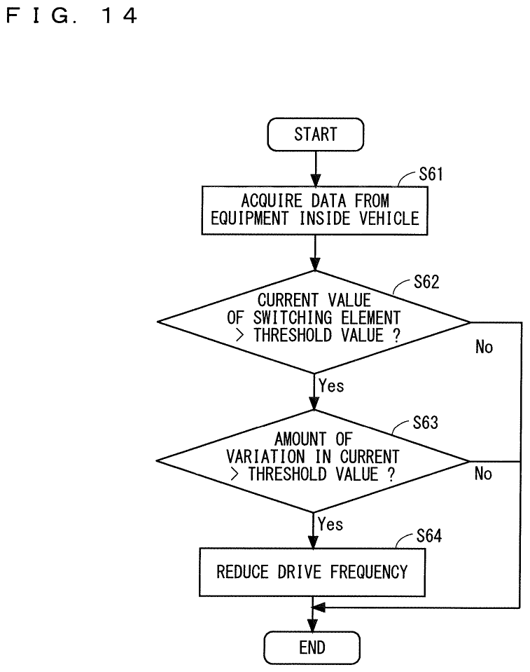

FIG. 14 is a flowchart showing an operation of the control device 60 in accordance with a variation of the fifth preferred embodiment. In Step S61, the data acquisition unit 61 acquires the data of the value of current Is flowing in the switching element 41 from the current sensor 43. In Step S62, the frequency switching determination unit 63 determines whether or not the value of current Is flowing in the switching element 41 exceeds the predetermined threshold value. Further, in Step S63, the frequency switching determination unit 63 determines whether or not the amount of variation dIs/dt in the current value exceeds the predetermined threshold value. Then, in Step S64, when the value of current Is flowing in the switching element 41 exceeds the predetermined value and the amount of variation dIs/dt in the current of the switching element 41 exceeds the predetermined value, the inverter control unit 64 outputs the command to reduce the drive frequency of the switching element 41 to the control circuit 23.

Also in the variation of the fifth preferred embodiment, the same effect as described in the first preferred embodiment can be produced.

### The Sixth Preferred Embodiment

In the first to fifth preferred embodiments, the control device 60 determines whether or not the predicted temperature of the switching element exceeds the predetermined value, on the basis of the data acquired from various equipment provided inside the electric Thiele and the prediction model or the like or the threshold value stored in the storage unit 62. Further, the control device 60 determines whether or not it is a state where the driver can allow a noise, on the basis of the data acquired from various equipment provided inside the electric vehicle and the model or the like or the threshold value. Herein, the prediction model or the like or the threshold value used for the above-described determination is set on the basis of a questionnaire or the like made at a test run in a development, or set in advance experimentally, empirically, or on the basis of a simulation or the like. In the sixth preferred embodiment, a case will be described, where the prediction model or the like or the threshold value used for the determination is created or determined by machine learning using AI (Artificial Intelligence). Further, though a case where AI is applied to the creation of the prediction model or the like in the first preferred embodiment will be described below, the same can apply to any other preferred embodiment.

<Learning Phase>

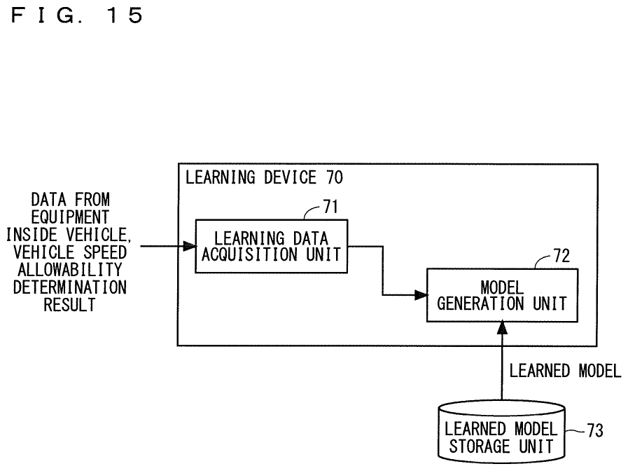

FIG. 15 is a block diagram showing a configuration of a learning device 70 for creating a learned model used in a control device 60a in accordance with the sixth preferred embodiment. The learning device 70 is provided inside the electric vehicle and generates a learned model used for inferring a result (hereinafter, referred to as a noise tolerance determination result) obtained by determining whether or not it is a state where the driver can allow a noise, by using learning data including the data acquired from the equipment provided inside the electric vehicle in a predetermined traveling pattern of the electric vehicle and a result (hereinafter, referred to as an allowability determination result) obtained by determining in advance whether or not the driver can allow a noise as to a sound generated from the power converter 20 in the traveling pattern. The learning device 70 includes a learning data acquisition unit 71, a model generation unit 72, and a learned model storage unit 73.

The learning data acquisition unit 71 acquires data obtained by associating the data of the accelerator opening A in a predetermined traveling pattern of the electric vehicle, the data of the vehicle speed of the electric vehicle, and a result obtained by determining whether or not the driver can allow a sound generated from the power converter 20 at the vehicle speed, as the learning data.

The model generation unit 72 learns the noise tolerance determination result on the basis of the learning data generated on the basis of a combination between the accelerator opening A and the vehicle speed of the electric vehicle in the predetermined traveling pattern, which are outputted from the learning data acquisition unit 71, and the allowability determination result at that time. In other words, the model generation unit 72 generates the learned model to be used for inferring an optimum noise tolerance determination result from the accelerator opening A and the vehicle speed in the predetermined traveling pattern of the electric vehicle and the allowability determination result. Herein, the learning data are data obtained by associating the accelerator opening A and the vehicle speed in the predetermined traveling pattern and the noise tolerance determination result. Further, an operation of associating a plurality of data to be used as the learning data may be performed before or after being acquired by the learning data acquisition unit 71.

As a learning algorithm used by the model generation unit 72, a well-known algorithm can be used, such as a supervised learning, an unsupervised learning, a reinforcement learning, or the like. As an example, a case on which a neural network is applied will be described.

The model generation unit 72 learns the noise tolerance determination result by the so-called supervised learning in accordance with, for example, a neural network model. Herein, the supervised learning refers to a method in which a combination of data of an input and a result (label) is given to the learning device 70 and the learning device 70 learns the characteristics of the learning data and infers a result from an input.

The neural network consists of an input layer formed of a plurality of neurons, a middle layer (hidden layer) formed of a plurality of neurons, and an output layer formed of a plurality of neurons. The middle layer may be one layer, or two layers or more.

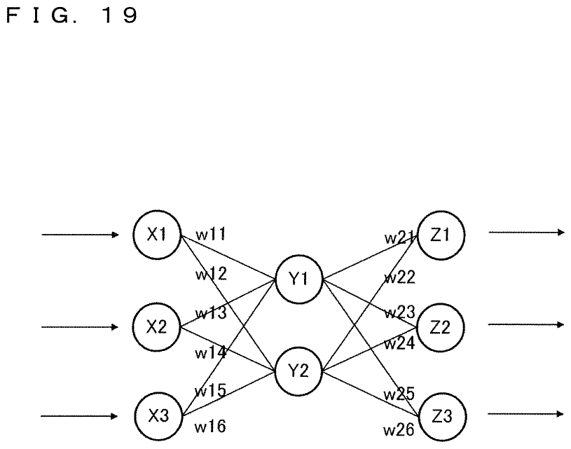

In such a three-layer neural network as shown in FIG. 19, for example, when a plurality of inputs are inputted to the input layer (X1 to X3), each value thereof is multiplied by a weight W1 (w11 to w16) and the product is inputted to the middle layer (Y1 to Y2), and then the result is further multiplied by another weight W2 (w21 to w26) and the product is outputted from the output layer (Z1 to Z3). The output result depends on respective values of the weights W1 and W2.

In the present application, the neural network learns a result obtained by determining whether or not it is a state where the driver can allow a noise, by the so-called supervised learning in accordance with the learning data generated on the basis of a combination between the accelerator opening A and the vehicle speed of the electric vehicle in the predetermined traveling pattern, which are acquired by the learning data acquisition unit 71, and the allowability determination result at that time.

In other words, the neural network performs learning by adjusting the weights W1 and W2 so that the result which is outputted from the output layer as a result of inputting the accelerator opening A and the vehicle speed of the electric vehicle to the input layer should get closer to the allowability determination result.

The model generation unit 72 generates the learned model by performing the above-described learning and outputs the learned model.

The learned model storage unit 73 stores therein the learned model outputted from the model generation unit 72. The learned model which is generated thus causes the control device 60a described later to operate so as to output a determination result (i.e., the noise tolerance determination result) on whether or not it is a state where the driver can allow a noise, on the basis of the data (i.e., the accelerator opening A and the vehicle speed of the electric vehicle) acquired from the equipment provided inside the vehicle in the predetermined traveling pattern of the electric vehicle and the result (i.e., the allowability determination result) obtained by determining in advance whether or not the driver can allow a noise in each traveling pattern.

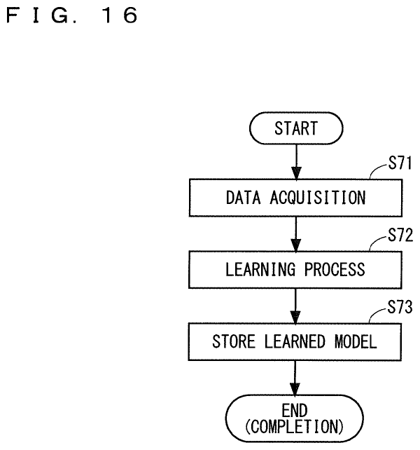

Next, with reference to FIG. 16, a process in which the learning device 70 performs learning will be described. FIG. 16 is a flowchart relating to a learning process of the learning device 70.

In Step S71, the learning data acquisition unit 71 acquires the accelerator opening A and the vehicle speed of the electric vehicle in a predetermined traveling pattern and the allowability determination result at that time. Further, though the accelerator opening A and the vehicle speed and the allowability determination result at that time are acquired at the same time, only if the accelerator opening A and the vehicle speed and the allowability determination result are inputted, being associated with one another, the accelerator opening A and the vehicle speed and the data of the allowability determination result may be acquired at different timings.

In Step S72, the model generation unit 72 learns the noise tolerance determination result by the sip-called supervised learning in accordance with the learning data generated on the basis of a combination between the accelerator opening A and the vehicle speed acquired by the learning data acquisition unit 71 and the allowability determination result, and generates the learned model.

In Step S73, the learned model storage unit 73 stores therein the learned model generated by the model generation unit 72.

<Exploitation Phase>

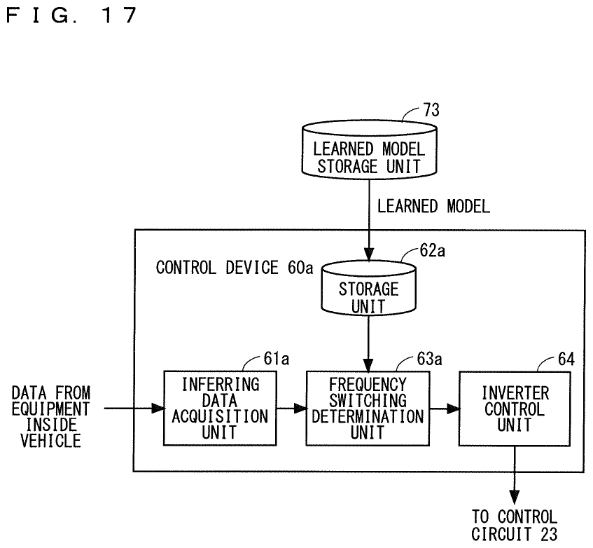

FIG. 17 is a block diagram showing a configuration of the control device 60a in accordance with the sixth preferred embodiment. The control device 60a is provided inside the electric vehicle and acquires data from the equipment provided inside the electric vehicle in a predetermined traveling pattern of the electric vehicle, and outputs the noise tolerance determination result from the acquired data, by using the learned model used for inferring the noise tolerance determination result from the data acquired in the traveling pattern. The control device 60a is provided, for example, instead of the control device 60 in the control system 101 described in the above-described first preferred embodiment, and is an electronic control unit (ECU) which has the same function as that of the control device 60 and controls the operation of the power converter 20. The control device 60a includes an inferring data acquisition unit 61a, a storage unit 62a, a frequency switching determination unit 63a, and the inverter control unit 64.

The inferring data acquisition unit 61a acquires the data of the accelerator opening A from the accelerator position sensor 51 and acquires the data of the vehicle speed of the electric vehicle from the vehicle speed sensor 52.

The storage unit 62a stores therein the learned model generated by the learning device 70.

By using the learned model stored in the storage unit 62a, the frequency switching determination unit 63a infers the noise tolerance determination result to be obtained from the learned model. In other words, by inputting the data of the accelerator opening A and the data of the vehicle speed of the electric vehicle which are acquired by the inferring data acquisition unit 61a, to the learned model, the noise tolerance determination result inferred from the accelerator opening A and the vehicle speed can be outputted.

Further, in the sixth preferred embodiment, though the case has been described, where the noise tolerance determination result is outputted by using the learned model obtained by the model generation unit 72 through learning in the test run of the electric vehicle, there may be a case where the learned model is acquired from the outside, such as any other electric vehicle or the like and the noise tolerance determination result is outputted on the basis of this learned model.

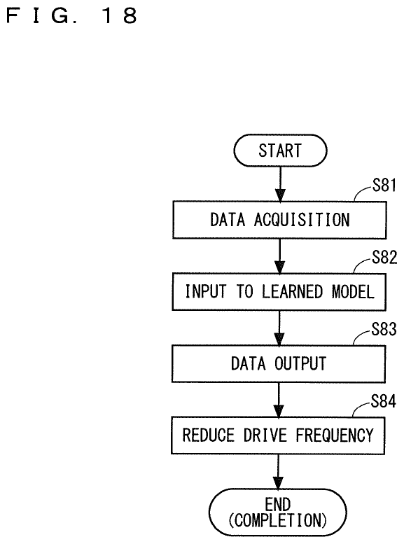

Next, with reference to FIG. 18, a process for obtaining the noise tolerance determination result by using the control device 60a and switching the drive frequency of the switching element on the basis of the determination result will be described.

In Step S81, the inferring data acquisition unit 61a acquires the data of the accelerator opening A from the accelerator position sensor 51 and acquires the data of the vehicle speed of the electric vehicle from the vehicle speed sensor 52.

In Step S82, the frequency switching determination unit 63a inputs the data of the accelerator opening A and the data of the vehicle speed of the electric vehicle to the learned model stored in the storage unit 62a, and obtains the noise tolerance determination result.

In Step S83, the frequency switching determination unit 63a outputs the noise tolerance determination result obtained from the learned model, to the inverter control unit 64.

In Step S84, the inverter control unit 64 outputs the command to reduce the drive frequency of the switching element included in the power converter 20 to the control circuit 23, on the basis of the outputted noise tolerance determination result. It is thereby possible to actually reduce the drive frequency of the switching element.

Also in the sixth preferred embodiment, the same effect as described in the first to fifth preferred embodiments can be produced.

Further, in the sixth preferred embodiment, though the case has been described, where the supervised learning is applied to the learning algorithm used by the model generation unit 72, this is only one exemplary case. As the learning algorithm, the reinforcement learning, the unsupervised learning, a semi-supervised learning, or the like, as well as the supervised learning, can be applied.

Furthermore, the learned model storage unit 73 may be a memory included in the learning device 70 or the control device 60a, or may be formed of an external memory, a memory included in any other device, or the like.

Further, the learned model generated by the model generation unit 72 is not limited to one stored in the learned model storage unit 73. The learned model may be stored in, for example, a computer-readable storage medium, such as an optical disk or the like. In this case, the learned model generated by the model generation unit 72 is stored in the storage medium, instead of being stored in the learned model storage unit 73. Then, the control device 60a stores the learned model acquired from the storage medium into the storage unit 62a, to be used to infer the noise tolerance determination result, as described above.

Furthermore, the learning device 70 is used to learn the noise tolerance determination result in the test run of the electric vehicle, but is not limited to one provided inside the electric vehicle. The control device 60a is also used to infer the noise tolerance determination result in the run of the electric vehicle by using the learned model generated by the learning device 70, but is not limited to one provided inside the electric vehicle. Each of the learning device 70 and the control device 60a may be, for example, a device provided separately from the electric vehicle and connected to the electric vehicle via a network. Further, each of the learning device 70 and the control device 60a may be incorporated in the electric vehicle. Moreover, each of the learning device 70 and the control device 60a may exist on a cloud server.

Further, not only the case where the whole configuration of the learning device 70 and the control device 60a is connected to the electric vehicle via the network or exists on the cloud server, there may be also a configuration where any one of the learning data acquisition unit 71, the model generation unit 72, the learned model storage unit 73, the inferring data acquisition unit 61a, the storage unit 62a, the frequency switching determination unit 63a, and the inverter control unit 64, which are part of the functions that the learning device 70 and the control device 60a have, is connected to the electric vehicle via the network or exists on the cloud server.

Furthermore, the model generation unit 72 may learn the noise tolerance determination result in accordance with the learning data generated for a plurality of electric vehicles. Further, the model generation unit 72 may acquire the learning data from the plurality of electric vehicles which are used in the same country, area, or the like, or may learn the noise tolerance determination result by using the learning data collected from the plurality of electric vehicles operating independently in different countries, areas, or the like. Furthermore, the electric vehicle from which the learning data are collected can be added to or removed from the target electric vehicles in the middle of the process. Further, the learning device 70 which learns the noise tolerance determination result as to an electric vehicle may be applied to a different electric vehicle and relearn the noise tolerance determination result as to the different electric vehicle to update the result.

Further, as the learning algorithm used by the model generation unit 72, deep learning in which extraction of a feature value is learned may be used, or machine learning may be performed in accordance with any other well-known method, such as a genetic programming, a functional logic programming, a support vector machine, or the like.

Next, a variation of the sixth preferred embodiment will be described. The variation of the sixth preferred embodiment is common to the sixth preferred embodiment in that the learned model generated by the machine learning using the AI is used when determination is made on whether or not it is a state where the driver can allow a noise, instead of using the prediction model or the like or the threshold value which is set on the basis of a questionnaire result, a simulation result, or the like in the test run. In the variation of the sixth preferred embodiment, additionally to this, learning on the state where the driver cannot allow a noise is reinforced and an inference operation on the noise tolerance determination result is corrected so that the drive frequency of the switching element is not reduced in the state where the driver cannot allow a noise.

In a case where the AI is applied to the creation of the prediction model or the like in the first preferred embodiment, for example, by using the data obtained by associating the data of the accelerator opening A in a predetermined traveling pattern, the data of the vehicle speed of the electric vehicle, and the allowability determination result in the traveling pattern, as the learning data, the model generation unit 72 can generate the learned model by machine learning, as described above.

In this case, for example, in a case where a time period for the transition from a state where it is determined to be necessary to switch the drive frequency of the switching element to another state where it is determined to be unnecessary to switch the drive frequency of the switching element is very short, among the data used as the learning data, specifically, in a case where a state where a high load is applied to the switching element lasts for a very short time, such as a case where an accelerator operation of the driver is canceled immediately after the accelerator pedal is depressed, or the like case, it cannot be determined that the driver shows his will to allow a noise. For this reason, switching of the drive frequency in such a case is not allowed by the driver and is not thought appropriate. Therefore, for the data in such a case, it is necessary to correct the inference operation in the learned model so that the noise tolerance determination result indicating that it is not a state where the driver can allow a noise should be outputted.

Herein, as to the data (hereinafter, referred to as unnecessary switching process data) in a case where a time period for the transition (or a time period while a state lasts where a high load is applied to the switching element, hereinafter, referred to as a switching process time) from a state where it is determined to be necessary to switch the drive frequency of the switching element to another state where it is determined to be unnecessary to switch the drive frequency of the switching element is very short, if the data is associated with the allowability determination result indicating that the driver cannot allow a noise, there arises no problem when the unnecessary switching process data are used as the learning data. On the other hand, if the unnecessary switching process data is associated with the allowability determination result indicating that the driver can allow a noise, it becomes necessary to correct the inference operation when the data are used as the learning data.

A method of correcting the inference operation in the learned model will be described below. First, a threshold value tb used for determining whether or not switching of the drive frequency is needed is set in advance. The model generation unit 72 of the learning device 70 performs learning by using, for example, the learning data including the data obtained by associating the data of the accelerator opening A in the predetermined traveling pattern, the data of the vehicle speed of the electric vehicle, the allowability determination result indicating that the driver can allow a noise in the traveling pattern, and the switching process time in the traveling pattern.

At that time, the model generation unit 72 determines whether or not the switching process time in the traveling pattern is not longer than the threshold value tb which is set in advance. Then, when the switching process time in the traveling pattern is longer than the threshold value tb, the model generation unit 72 learns that it is a state where the driver can allow a noise, on the basis of the allowability determination result indicating that the driver can allow a noise. On the other hand, when the switching process time in the traveling pattern is not longer than the threshold value tb, the model generation unit 72 learns that it is not a state where the driver can allow a noise, regardless of the allowability determination result indicating that the driver can allow a noise. The model generation unit 72 thereby generates a learned model used for inferring a more appropriate noise tolerance determination result.

In the learned model generated thus, when the data of the accelerator opening A in the predetermined traveling pattern, the data of the vehicle speed of the electric vehicle, and the switching process time in the traveling pattern are inputted, in a case where the switching process time is longer than the threshold value tb, outputted is a noise tolerance determination result on the basis of the data of the accelerator opening A in the traveling pattern and the data of the vehicle speed of the electric vehicle. On the other hand, in a case where the switching process time is not longer than the threshold value tb, outputted is a noise tolerance determination result indicating that it is not a state where the driver can allow a noise, regardless of the data of the accelerator opening A in the traveling pattern and the data of the vehicle speed of the electric vehicle.

In other words, in the above-described learned model, when the unnecessary switching process data indicating the switching process time is very short are inputted, outputted is the noise tolerance determination result indicating that it is not a state where the driver can allow a noise. The frequency switching determination unit 63a of the control device 60a infers the noise tolerance determination result obtained from the learned model, as described above, by using the learned model generated thus.

Also in the variation of the sixth preferred embodiment, the same effect as described in the first to sixth preferred embodiments can be produced.

Further, in the variation of the sixth preferred embodiment, by using the learned model used for inferring a more appropriate noise tolerance determination result, it is possible to more appropriately achieve both the response to the noise generated from the power converter 20 and suppression of the heat generation of the switching element and improvement in the drive efficiency.

Furthermore, in the variation of the sixth preferred embodiment, though the case has been described, where the AI is applied to the generation of the prediction model or the like in the first preferred embodiment, this is only one exemplary ease. In a case where this is applied to the second preferred embodiment, for example, the model generation unit 72 of the learning device 70 performs learning by using the data obtained by associating the information on the gradient of the road surface on which the electric vehicle travels, which is included in the data on the scheduled travel route, the data of the vehicle speed of the electric vehicle, the allowability determination result at that time, and the data indicating that the electric vehicle does not travel a climbing road, as the learning data, to learn that it is not a state where the driver can allow a noise, regardless of the allowability determination result indicating that the driver can allow a noise. As the data indicating that the electric vehicle does not travel a climbing road, used are the data indicating that the electric vehicle deviates from the scheduled travel route immediately before the electric vehicle enters the climbing d or the data indicating that the electric vehicle does not actually travel the climbing road by sudden stop with sudden braking, or the like.

In the learned model generated thus, when the data indicating that the electric vehicle does not travel a climbing road are acquired at the same time, additionally to the information on the gradient of the road surface on which the electric vehicle travels, which is included in the data on the scheduled travel route, and the data of the vehicle speed of the electric vehicle, even if usually it is inferred, from the data on the scheduled travel route, that the electric vehicle will travel the climbing road near-futuristically and it is determined that it is a state where the driver can allow a noise, outputted is the noise tolerance determination result indicating that it is not a state where the driver can allow a noise.

Further, in a case where this is applied to the third preferred embodiment or the variation thereof, for example, the model generation unit 72 of the learning device 70 performs learning by using the learning data including the data obtained by associating the information indicating that the electric vehicle performs autonomous driving by using the driver assistance device, and as necessary, the data on the traveling direction of the electric vehicle, the data of the accelerator opening A of the electric vehicle, the allowability determination result at that time, and the switching process time in the traveling pattern. At that time, like in the above-described case, when the switching process time is longer than the threshold value tb, the model generation unit 72 of the learning device 70 learns that it is a state where the driver can allow a noise, on the basis of the allowability determination result indicating that the driver can allow a noise. On the other hand, when the switching process time in the traveling pattern is not longer than the threshold value tb, the model generation unit 72 of the learning device 70 learns that it is not a state where the driver can allow a noise, regardless of the allowability determination result indicating that the driver can allow a noise.

As the case where the switching process time is very short in this example, specifically, considered is a case where an accelerator operation of the driver is canceled immediately after the accelerator pedal is depressed, a case where the autonomous driving by the driver assistance device is canceled immediately after the driver assistance device determines to automatically make overtaking, or the like case.

Also in the learned model generated thus, when the unnecessary switching process data indicating that the switching process time is very short are inputted, outputted is the noise tolerance determination result indicating that it is not a state where the driver can allow a noise.

In summary of the above, in a case where the unnecessary switching process data indicating that switching of the drive frequency of the switching element is not actually needed are inputted, such as a case where the switching process is not substantially needed since the switching process time from the time of performing the switching determination of the drive frequency of the switching element to the time of actually switching the drive frequency is very short, a case where the switching process is not actually needed since the electric vehicle does not travel a climbing road, or the like case, the learned model may be configured to output the noise tolerance determination result indicating that it is not a state where the driver can allow a noise, regardless of other input data. When the model generation unit 72 of the learning device 70 generates such a learned model and the frequency switching determination unit 63a of the control device 60a uses the learned model, it becomes possible to infer a more appropriate noise tolerance determination result.

Further, in the sixth preferred embodiment and the variation thereof, though the case has been described, where the learning device 70 and the control device 60a are different device configurations, there may be a configuration where the control device 60a also has the function of the learning device 70, in other words, may be a device configuration where the control device 60a includes the learning device 70 therein. In this case, the learning data acquisition unit 71 and the inferring data acquisition unit 61a may be implemented by (constituted of) the same function, and for example, may be implemented by the common program processing. Furthermore in this case, when the learned model storage unit 73 and the storage unit 62a are formed of the same memory or the like, since it is unnecessary to move the generated learned model from the memory or the like storing it, it thereby becomes unnecessary to transmit and receive the learned model through the storage medium or the like.

Further, as described above, there may be a configuration where the whole or part of the configuration of the learning device 70 or the control device 60a is connected to the electric vehicle via the network or exists on the cloud server.

<In Closing>

Further, in the preferred embodiments described above in the present specification, the quality of material, the material, the size, the shape, the relative arrangement relation, the implementation condition, or the like of each constituent element is described in some cases, but this is only one example in all aspects and not restrictive. Therefore, an indefinite number of modifications, variations, and equivalents not exemplarily shown are assumed within the scope of the technique disclosed in the present embodiments. These modifications, variations, and equivalents include, for example, exemplary cases where any constituent element is deformed, added, and/or omitted, and further where at least one constituent element in at least one preferred embodiment is extracted and combined with a constituent element in any other preferred embodiment.

Furthermore, in the above-described preferred embodiments, when it is described that something comprises “a” constituent element, something may comprise “one or more” constituent elements, as long as no contradiction arises. Moreover, each constituent element is a conceptual unit which includes cases where one constituent element is constituted of a plurality of structural objects and where one constituent element corresponds to part of a structural object.

Further, any description in the present specification is not recognized as the prior art.

Furthermore, the preferred embodiments may be freely combined, or may be changed or omitted as appropriate.

### EXPLANATION OF REFERENCE SIGNS

10 power supply, 20 power converter, 21 main converter circuit, 22 drive circuit, 23 control circuit, 25 frequency divider circuit, 26 switch, 27 switch, 30 motor, 40 semiconductor device, 41 switching element, 42 temperature sensor, 43 current sensor, 51 accelerator position sensor, 52 vehicle speed sensor, 53 navigation device, 54 driver assistance device, 55 direction indicator, 56 fuel indicator, 57 battery capacity meter, 60, 60a control device, 61 data acquisition unit, 61a inferring data acquisition unit, 62, 62a storage unit, 63, 63a frequency switching determination unit, 64 inverter control unit, 66 transmitter/receiver device, 67 processor, 68 memory (ROM), 69 memory (RAM), 70 learning device, 71 learning data acquisition unit, 72 model generation unit, 73 learned model storage unit, 101, 201, 301, 401, 501 control system

1. A control system for controlling an operation of a power converter which performs power conversion between a motor for driving a vehicle and a power supply, comprising:
a data acquisition circuitry for acquiring data from equipment provided inside a vehicle; and
a control circuitry for reducing a drive frequency of a switching element included in the power converter when it is determined, on the basis of the data acquired by the data acquisition circuitry, that it is a state where a driver can allow a noise.

2. The control system according to claim 1, further comprising:
a storage for storing therein data obtained by associating a predetermined traveling pattern of the vehicle with a result obtained by determining in advance whether or not a driver can allow a sound generated from the power converter in the traveling pattern, for each traveling pattern; and
a determination circuitry for determining whether or not a current traveling state of the vehicle coincides with the traveling pattern, on the basis of the data acquired by the data acquisition circuitry.

3. The control system according to claim 2, wherein
the storage stores therein a prediction model used for predicting a future load of the motor or the power converter on the basis of the data acquired from the equipment and a relational expression used for obtaining a temperature of the switching element on the basis of the load of the motor or the power converter and characteristics of the switching element, and
the determination circuitry predicts a future temperature of the switching element on the basis of the prediction model and the relational expression, and when the predicted temperature of the switching element exceeds a predetermined value, the determination circuitry performs determination on whether or not the current traveling state of the vehicle coincides with the traveling pattern.

4. The control system according to claim 1, wherein
the control circuitry determines whether or not it is a state where a driver can allow a noise, on the basis of the predicted temperature of the switching element and a vehicle speed of the vehicle.

5. The control system according to claim 1, wherein
the equipment includes an accelerator position sensor for detecting an accelerator opening of the vehicle and a vehicle speed sensor for detecting a vehicle speed of the vehicle,
the data acquisition circuitry acquires data of the accelerator opening of the vehicle from the accelerator position sensor and data of the vehicle speed of the vehicle from the vehicle speed sensor, and
the control circuitry reduces a drive frequency of the switching element when the amount of variation in the accelerator opening of the vehicle exceeds a predetermined value and the vehicle speed of the vehicle exceeds a predetermined value.

6. The control system according to claim 1, wherein
the equipment includes a navigation device having position information of the vehicle and a vehicle speed sensor for detecting a vehicle speed of the vehicle,
the data acquisition circuitry acquires data on a scheduled travel route of the vehicle from the navigation device and data of the vehicle speed of the vehicle from the vehicle speed sensor, and
the control circuitry reduces a drive frequency of the switching element when it is predicted from the data on the scheduled travel route of the vehicle that a load of the vehicle should increase and the vehicle speed of the vehicle exceeds a predetermined value.

7. The control system according to claim 1, wherein
the equipment includes a navigation device having position information of the vehicle and an acceleration sensor for detecting an acceleration of the vehicle,
the data acquisition circuitry acquires data on a scheduled travel route of the vehicle from the navigation device and data of the acceleration of the vehicle from the acceleration sensor, and
the control circuitry reduces a drive frequency of the switching element when it is predicted from the data on the scheduled travel route of the vehicle that a load of the vehicle should increase and the acceleration of the vehicle exceeds a predetermined value.

8. The control system according to claim 6, wherein
the control circuitry predicts whether or not the load of the vehicle should increase, on the basis of the data on the scheduled travel route of the vehicle including information on a gradient of a road surface on which the vehicle travels.

9. The control system according to claim 1, wherein
the equipment is a driver assistance device for assisting driving of the vehicle,
the data acquisition circuitry acquires data on a driving state of the vehicle from the driver assistance device, and
the control circuitry reduces a drive frequency of the switching element when the driver assistance device makes overtaking.

10. The control system according to claim 1, wherein
the equipment includes a driver assistance device for assisting driving of the vehicle, an accelerator position sensor for detecting an accelerator opening of the vehicle, and a direction indicator displaying a traveling direction of the vehicle,
the data acquisition circuitry acquires data on a driving state of the vehicle from the driver assistance device, data of the accelerator opening of the vehicle from the accelerator position sensor, and data on the traveling direction of the vehicle from the direction indicator, and
the control circuitry reduces a drive frequency of the switching element when it is a state where the driver assistance device performs driver assistance and it is determined, on the basis of the data of the accelerator opening of the vehicle and the data on the traveling direction of the vehicle, that a driver should make overtaking.

11. The control system according to claim 9, wherein
the driver assistance device automatically performs a driving operation for causing the vehicle to travel at a predetermined vehicle speed while keeping an inter-vehicle distance between the vehicle and another vehicle constant.

12. The control system according to claim 1, wherein
the control circuitry determines whether or not it is a state where a driver can allow a noise, on the basis of a cruising range where the vehicle can travel in the future.

13. The control system according to claim 1, wherein
the equipment is a fuel indicator for detecting the remaining amount of fuel of the vehicle,
the data acquisition circuitry acquires data of the remaining amount of fuel of the vehicle from the fuel indicator, and
the control circuitry reduces a drive frequency of the switching element when the remaining amount of fuel of the vehicle falls below a predetermined value.

14. The control system according to claim 1, wherein
the equipment is a battery capacity meter for detecting a battery remaining capacity of the vehicle,
the data acquisition circuitry acquires data of the battery remaining capacity of the vehicle from the battery capacity meter, and
the control circuitry reduces a drive frequency of the switching element when the battery remaining capacity of the vehicle falls below a predetermined value.

15. The control system according to claim 1, wherein
the control circuitry determines whether or not it is a state where a driver can allow a noise, on the basis of the temperature and the amount of variation in the temperature of the switching element.

16. The control system according to claim 1, wherein
the equipment is a temperature sensor for detecting the temperature of the switching element,
the data acquisition circuitry acquires data of the temperature of the switching element from the temperature sensor, and
the control circuitry reduces a drive frequency of the switching element when the temperature of the switching element exceeds a predetermined value and the amount of variation in the temperature of the switching element exceeds a predetermined value.

17. The control system according to claim 1, wherein
the equipment is a current sensor for detecting a current value of the switching element,
the data acquisition circuitry acquires data of the current value of the switching element from the current sensor, and
the control circuitry reduces a drive frequency of the switching element when the current value of the switching element exceeds a predetermined value and the amount of variation in the current value of the switching element exceeds a predetermined value.

18. The control system according to claim 15, wherein
the power converter divides a frequency of a drive signal used for driving the switching element when the control circuitry reduces a drive frequency of the switching element.

19. A control device for controlling an operation of a power converter which performs power conversion between a motor for driving a vehicle and a power supply, comprising:
a data acquisition circuitry for acquiring data from equipment provided inside the vehicle;
a determination circuitry for determining whether or not it is a state where a driver can allow a noise, on the basis of the data acquired by the data acquisition circuitry; and
a control circuitry for outputting a command to reduce a drive frequency of a switching element included in the power converter when the determination circuitry determines that it is a state where a driver can allow a noise.

20. A control method for controlling an operation of a power converter which performs power conversion between a motor for driving a vehicle and a power supply, comprising:
acquiring data from equipment provided inside the vehicle;
determining whether or not it is a state where a driver can allow a noise, on the basis of the acquired data; and
reducing a drive frequency of a switching element included in the power converter when it is determined that it is a state where a driver can allow a noise.

21. A storage medium storing a program executed in a control device for controlling an operation of a power converter which performs power conversion between a motor for driving a vehicle and a power supply, wherein the program makes the control device execute:
determining whether or not it is a state where a driver can allow a noise, on the basis of data acquired from equipment provided inside the vehicle; and
outputting a command to reduce a drive frequency of a switching element included in the power converter when it is determined that it is a state where a driver can allow a noise.

22. An electric vehicle, comprising:
a power supply;
a motor for driving a vehicle;
a power converter for performing power conversion between the power supply and the motor; and
a control device for acquiring data from equipment provided inside the vehicle and reducing a drive frequency of a switching element included in the power converter when it is determined, on the basis of the acquired data, that it is a state where a driver can allow a noise.

23. A learning device, comprising:
a learning data acquisition circuitry for acquiring learning data including data acquired from equipment provided inside a vehicle in a predetermined traveling pattern of the vehicle and a result obtained by determining in advance whether or not a driver can allow a noise in the traveling pattern; and
a model generation circuitry for generating a learned model to be used for inferring, from the data acquired from the equipment provided inside the vehicle, whether or not it is a state where the driver can allow a noise, by using the learning data.

24. A control device, comprising:
an inferring data acquisition circuitry for acquiring data from equipment provided inside a vehicle in a predetermined traveling pattern of the vehicle; and
a frequency switching determination circuitry for outputting a determination result on whether or not it is a state where a driver can allow a noise, from the data acquired by the inferring data acquisition circuitry, by using a learned model to be used for inferring, from the data acquired from the equipment provided inside the vehicle in the traveling pattern, whether or not it is a state where the driver can allow a noise.

25. The control device according to claim 24, wherein
the vehicle has a power converter for performing power conversion between a power supply and a motor, and
the frequency switching determination circuitry outputs a determination result indicating that it is not a state where the driver can allow a noise when data are inputted, indicating that it is unnecessary to switch a drive frequency of a switching element included in the power converter.

26. The control device according to claim 25, wherein
the frequency switching determination circuitry outputs the determination result indicating that it is not a state where the driver can allow a noise when data are inputted, indicating that a time period for the transition from a state where it is determined to be necessary to switch a drive frequency of the switching element to another state where it is determined to be unnecessary to switch the drive frequency of the switching element is very short.

27. A learned model operated in a control device for controlling an operation of a power converter which performs power conversion between a motor for driving a vehicle and a power supply,
the learned model causing the control device to operate so as to output a determination result on whether or not it is a state where a driver can allow a noise, on the basis of data acquired from equipment provided inside the vehicle in a predetermined traveling pattern of the vehicle and a result obtained by determining in advance whether or not the driver can allow a noise in the traveling pattern.
